(19) United States
(12) Patent Application Publication
(10) Pub. No.: US 2020/0286069 A1
(43) Pub. Date: Sep. 10, 2020

(54) NFC TAG-ENABLED CLOUD-BASED TRANSACTIONS

(71) Applicant: ASSA ABLOY AB, Stockholm (SE)

(72) Inventor: Joseph Bernard Pearson, Cedar Park, TX (US)

(21) Appl. No.: 16/648,742

(22) PCT Filed: Sep. 19, 2018
(86) PCT No.: PCT/IB2018/001230

§ 371 Date: Mar. 19, 2020

Related U.S. Application Data
(60) Provisional application No. 62/561,090, filed on Sep. 20, 2017.

(51) Int. Cl. G06Q 20/32; G06Q 20/20; H04W 12/00; H04W 4/80

(52) U.S. Cl. CPC G06Q 20/3278; G06Q 20/204; H04W 4/80; H04W 12/009; H04W 12/00503; G06Q 20/3226

(57) ABSTRACT

A user of a mobile device may participate in one or more NFC-enabled cloud-based transactions by tapping the mobile device on a tag, receiving information from the tag over a secure channel, and transmitting the information to a cloud-based server. The cloud based server communicates with a store backend, which in turn communicates with a point-of-sale/service (POS) terminal associated with the tag. Transaction details are sent back to the mobile device via the POS terminal, the store backend, and the cloud payment server, and the user of the mobile device may approve the transaction details to initiate payment by the cloud payment server to the store backend for the transaction.

### CROSS-REFERENCE TO RELATED APPLICATIONS

This application claims the benefit of U.S. Provisional Patent Application No. 62/561,090, filed Sep. 20, 2017 and entitled “NFC Tag-Enabled Cloud-Based Transactions,” which is incorporated by reference herein in its entirety and for all purposes.

### FIELD

The present disclosure relates to the use of near-field communication (NFC) tags, and more specifically to systems and methods for NFC tag-enabled cloud-based transactions.

### BACKGROUND

NFC tags are often used in connection with systems and methods for securing access to a protected area. For example, a use may present an NFC tag to a reader device located at a door or other access point to a secured area. The NFC tag and the reader may exchange information. Based on the exchanged information a determination may be made as to whether to open the door or other access point and allow the user to enter the secured area.

### SUMMARY OF THE INVENTION

One or more trusted tags may be leveraged in connection with facilitating a transaction that may or may not also utilize a mobile communication device having an electronic wallet provided thereon. Users may authorize a transaction using a mobile device (e.g., smart phone, tablet, etc.), thus indicating an intention to approve the transaction by tapping a separate tag (e.g., an NFC tag) adjacent to, or associated with, a point of sale/service (POS) or, more specifically, a POS terminal.

In some embodiments, the system includes one or more tags (e.g., NFC-based tags that include a processor, computer memory, and an antenna that facilitates wireless communications), a mobile device carried by a purchasing user, a cloud payment application operating on the mobile device, a payment service, and/or a POS station/terminal. Details of illustrative system components and their basic interactions are provided herein.

The term “computer-readable medium,” as used herein, refers to any tangible storage medium that may be used to store instructions for execution by a processor. Such a medium may take many forms, including but not limited to, non-volatile media, and volatile media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, and any other memory chip or cartridge. When the computer-readable medium is configured as a database, it is to be understood that the database may be any type of database, such as relational, hierarchical, object-oriented, and/or the like. Accordingly, the disclosure is considered to include a tangible storage medium and prior art-recognized equivalents and successor media.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. The drawings are not to be construed as limiting the disclosure to only the illustrated and described examples.

FIG. 1A is a diagram of a system for making a purchase according to an embodiment of the present disclosure;

FIG. 1B is a block diagram of a mobile device according to an embodiment of the present disclosure;

FIG. 1C is a block diagram of a tag according to an embodiment of the present disclosure;

FIG. 1D is a block diagram of a point of sale/service terminal according to an embodiment of the present disclosure;

FIG. 1E is a block diagram of a cloud payment server according to an embodiment of the present disclosure;

FIG. 2 is a flowchart corresponding to a method of using the system of FIG. 1;

FIG. 3 is a diagram of a system for making a purchase from a mobile merchant according to an embodiment of the present disclosure;

FIG. 4 is a flowchart corresponding to a method of using the system of FIG. 3;

FIG. 5 is a diagram of a system for making a purchase at a drive-through according to an embodiment of the present disclosure;

FIG. 6 is a flowchart corresponding to a method of using the system of FIG. 5;

FIG. 7 depicts a conveyor belt according to an embodiment of the present disclosure;

FIG. 8 is a diagram of a system for redeeming coupons according to an embodiment of the present disclosure;

FIG. 9 is a flowchart corresponding to a method of using the system of FIG. 8;

FIG. 10 is a diagram of another system for redeeming coupons according to an embodiment of the present disclosure;

FIG. 11 is a flowchart corresponding to a method of using the system of FIG. 10;

FIG. 12 is a diagram of a system for making a purchase and redeeming coupons according to an embodiment of the present disclosure;

FIG. 13 is a flowchart corresponding to a method of using the system of FIG. 12;

FIG. 14 is a diagram of a system for receiving and accepting an offer according to an embodiment of the present disclosure;

FIG. 15 is a flowchart corresponding to a method of using the system of FIG. 15;

FIG. 16 is a diagram of a system for making a purchase from a table in a restaurant according to an embodiment of the present disclosure;

FIG. 17 is a flowchart corresponding to a method of using the system of FIG. 16; and

FIG. 18 is a diagram of a tag collection according to an embodiment of the present disclosure.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

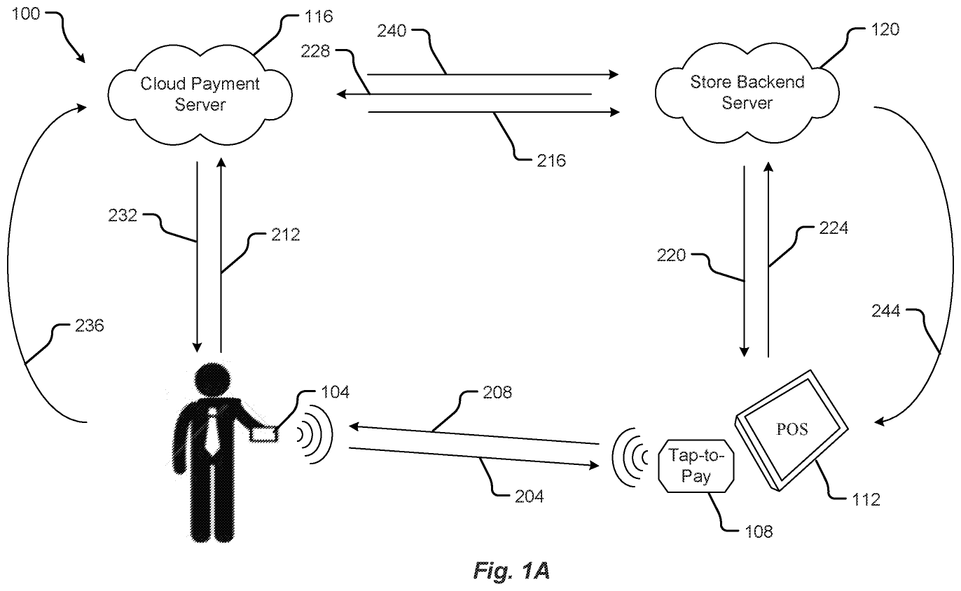

With reference first to FIGS. 1A-1E, a system 100 for NFC-enabled cloud-based transactions according to an embodiment of the present disclosure comprises a mobile device 104; a tag 108; a point-of-sale terminal 112 (e.g., in a brick and mortar retailer) that is associated with the tag 108; a cloud payment server 116 in communication with the mobile device 104; and a store backend computer or server 120 (which may also be cloud-based or otherwise network-accessible) in communication with the cloud payment server 116 and the point-of-sale/service (POS) terminal 112.

The mobile device 104 may be, for example, a smartphone, a tablet, laptop, or computer, and may comprise a processor 150, a user interface 151, a computer-readable memory 152, a network communication interface 156, a proximity-based communication interface 158, and an antenna 157 driven by an antenna driver 159.

The processor 150 may correspond to one or many microprocessors that are contained within the housing of the mobile device 104 together with, for example, the memory 152. In some embodiments, the processor 150 incorporates the functions of a Central Processing Unit (CPU) on a single Integrated Circuit (IC) or a few IC chips. The processor 150 may be a multipurpose, programmable device that accepts digital data as input, processes the digital data according to instructions stored in its internal memory, and provides results as output. The processor 150 implements sequential digital logic as it has internal memory. As with most known microprocessors, the processor 150 may operate on numbers and symbols represented in the binary numeral system.

The user interface 151 of the mobile device 104 may comprise one or more input devices 153 (e.g., keyboards, keypads, trackpads, mouse, buttons, touch-sensitive surfaces, pens, cameras, microphones) and one or more output devices 155 (e.g., a display screen, a speaker, a light-emitting diode, a haptic device). In some embodiments, the user interface 151 may comprise a single device providing input and output functionality (e.g., a touchscreen). The user interface 151 may facilitate user interaction with the mobile device 104, including by enabling the display of information by the mobile device 104 and the selection by a user of the mobile device 104 of one or more options displayed on the user interface 151.

The input device(s) 153 may include at least one device sensor. Among other things, a device sensor may be configured to detect a state of the mobile device 104 or location of the mobile device 104. Illustrative but non-limiting sensors include one or more biometric sensors (e.g., heart rate, body temperature and/or heat signature, blood pressure, etc.), capacitive sensors, light sensors, image sensors, temperature sensors, pressure sensors, contact sensors, magnetic sensors, radio indoor positioning sensors, location services sensors and/or devices, combinations thereof, and the like. As can be appreciated, one or more of these sensors may alternatively or additionally be incorporated into a wearable device. It is an aspect of the present disclosure that the processor 150 of the mobile device 104 may receive the sensor information and determine whether the mobile device 104 is in motion, still, lit or unlit, etc., and/or combinations thereof. Other suitable sensors may include one or more of a gyroscope, accelerometer, transducer, and/or other mechanical detection component that are each configured to detect a force and/or motion associated with the mobile device 104.

Yet another type of suitable sensor that can be included in the input device(s) 153 is a location sensor. A location sensor may be configured to determine a geographical location and/or position of the mobile device 104. In one embodiment, this location may be based on Global Positioning System (GPS) data provided by a GPS module of the mobile device 104. In some embodiments, the location of the mobile device 104 may be provided based on cell tower data, WiFi information, iBeacon information, and/or some other location information provided by a component of the mobile device 104. In one embodiment, the authentication of a user may be based at least partially on determining a location of the mobile device 104. In some embodiments, one or more features of the mobile device 104 may be controlled based on a location and/or state of the mobile device 104.

The computer-readable memory 152 of the mobile device 104 may store, for example, instructions for execution by the processor (e.g., instructions corresponding to an operating system of the mobile device 104, and/or instructions corresponding to one or more apps installed on the mobile device 104). In some embodiments, the memory 152 stores a mobile payments application, which may contain instructions for execution by the processor 150 that enable the processor 150 to carry out various steps of the methods described herein. The memory 152 may also store a mobileID 154, which represents data such as mobile device identifier information. The mobileID 154 may comprise personalized data for a user of the mobile device 104, such as the user's name, a user alias, a phone number, and/or credit card information. In a more specific example, the mobileID 154 may include a unique identifier for the user of the mobile device 104 that is understood only by the cloud payment server 116 and that was provisioned to the user's mobile device 104 when the user (or a related entity) signed up as a customer of the entity operating the cloud payment server 116. This mobileID 154 might be described as a ‘derived credential’ as the information contained therein may be identity information derived from other information provided by the user to the cloud payment server to demonstrate the user's identity and authority to make transactions requiring payments.

The network communication interface 156 is equipped to communicate via network communication protocols, one or more of which may be used for communicating with the cloud payment server 116. The network communication interface 156 may be equipped to communicate via TCP/IP, UDP, RTP, GSM, LTE, CDMA, Wi-Fi, and/or other network communication protocols.

The proximity-based communication interface 158 is equipped to communicate via NFC or other proximity-based communication protocols, one or more of which may be used for communicating with the tag 108. The proximity-based communication interface 158 may be equipped to communicate, for example, via NFC, Bluetooth®, Bluetooth low energy (BLE), Zig-Bee, infrared, ultrasonic, IEEE 802.11N, and/or other proximity-based protocols.

One or both of the network communication interface 156 and the proximity-based communication interface 158 may utilize the antenna 157. The antenna 157 enables wireless communications between the mobile device 104 and other system elements described herein, including the tag 108, the cloud payment server 116, and the POS terminal 112. The antenna driver 159 may facilitate use of the antenna 157 for a given network or proximity-based communication protocol. In some embodiments, the antenna 157 may be an RF antenna, and as such, may transmit RF signals through free space.

In some embodiments, the mobile device 104 may include a power module. The power module may be configured to provide power to the powered components of the mobile device 104 so as to allow such components to operate. The power module may store power in a capacitor of the power module. In one embodiment, electronics in the power module may store energy in the capacitor and turn off when an RF field is present. The power module may include a built-in power supply (e.g., battery) and/or a power converter that facilitates the conversion of externally-supplied AC power into DC power that is used to power the various components of the mobile device 104. In some embodiments, the power module may also include some implementation of surge protection circuitry to protect the components of the mobile device 104 from power surges.

The tag 108 may comprise a processor 160, computer-readable memory 162 or another data storage device, and a proximity-based communication interface 164 (which may include, for example, a radio and/or an antenna).

The processor 160 may be similar or identical to processor 150. For instance, the processor 160 may include one or more CPUs, General Processing Units (GPUs), Integrated Circuit (IC) chips, microprocessors, etc. Alternatively, or additionally, the processor 160 may include other hardware components that are capable of executing the instructions stored in memory 162.

The computer-readable memory 162 may store, for example, data describing the specific physical POS terminal 112 with which the tag 108 is associated, software running on the POS terminal 112, a retailer that operates the POS terminal 112, or any combination thereof. The computer-readable memory 162 may also store, for example, a serial number uniquely identifying the tag 108 from among a plurality of other tags (referred to herein as a TagID). The TagID stored in the tag 108 may comprise or correspond to, for example, information about the vendor that produced the tag 108, the model number of the tag 108, and the unit number of the tag 108 within the model sequence of the tag 108.

The proximity-based communication interface 164 is equipped to communicate via NFC or other proximity-based communication protocols, one or more of which may be used for communicating with the mobile device 104. The proximity-based communication interface 164 may be equipped to communicate, for example, via NFC, Bluetooth®, Bluetooth low energy (BLE), Zig-Bee, infrared, ultrasonic, IEEE 802.11N, and/or other proximity-based protocols.

The physical design of the tag 108 may be similar to any type of known or yet-to-be-developed tag, and may support a combination of the features found in such tags. The tag 108 may be a passive device, operable only when energy is provided by an external source (e.g., when a mobile device 104 generates an electro-magnetic field that encompasses or passes through the tag 108) or the tag 108 may be an active device, comprising an independent energy source.

The tag 108 may be an NFC tag. NFC tags that may useable as the tag 108 include, but are not limited to, (1) HID® Trusted Tags®, which utilize HID®'s Trusted Tag® Services (back-end software/server that authenticates each tag read before sharing data with an individual's phone or other NFC reading device) and offer SEOS® protection of all communications; (2) HID® Inlays & Labels; (3) HID® Global Brick Tags, which are optimized for placement on metal assets; (4) HID® InLine Tag™ Plate UHF transponders, which mount flush to any surface and allow rugged treatment; and (5) HID® Global Epoxy Tag RFID transponders, which are optimized for harsh conditions; are resistant to fuels, mineral oils, petroleum, and salt mist; repel moisture even in high temperature and high pressure environments; and offer a smooth surface which may be imprinted with customized visual codes or artwork.

By way of explanation, SEOS® has the ability to generate a one-time password that amounts to a specific version of a URL that will not be used more than once for a given tag. The URL must then be verified during each read, by the Trusted Tag® Services software running on HID®'s cloud-based server, before it transmits data to an NFC reading device.

Although some examples provided herein describe the systems and methods of the present disclosure with respect to an NFC-enabled tag, it should be appreciated that embodiments of the present disclosure are not so limited. For instance, a tag that utilizes Bluetooth communications or some other proximity-based communication protocol (e.g., infrared, ultrasonic, and/or IEEE 802.11N) may be used instead of an NFC-enabled tag. Furthermore, although SEOS® is described as one possible platform used to secure tag communications, it should be appreciated that other protocols or platforms may be used to secure the communications between tags and other electronic devices. Additionally, the tag 108 may transmit information in unencrypted form. The example of a SEOS® protected tag is simply provided as an illustrative example. The tag 108 might also contain additional information, such as a QR code or a barcode display containing the same information presented on the tag 108, where the mobile device 104 takes a photo of the barcode or QR code to obtain the information in lieu of reading the tag 108.

In the methods described herein, when NFC is being used for the communication channel between mobile device 104 and the tag 108, the mobile device 104 and the tag 108 may have their respective interfaces/antennas inductively coupled to one another at which point the devices may authenticate or mutually authenticate with one another. Following authentication, the tag 108 may request a key or multiple keys from the mobile device 104, or the mobile device 104 may offer a key or multiple keys to the tag 108. Upon receiving the key(s) from the mobile device 104, the tag 108 may analyze the key(s) and determine if the key(s) are valid and, if so, allow the holder/user of the mobile device 104 access to the asset protected by the tag 108. It should be appreciated that the mobile device 104 may alternatively or additionally be configured to analyze information received from the tag 108 in connection with making an access control decision and/or in connection with making a decision whether or not to provide key(s) to the tag 108.

When BLE or some other non-inductive protocol (e.g., Wi-Fi) is being used for a communication channel between the mobile device 104 and the tag 108, then the tag 108 and mobile device 104 may perform a discovery routine prior to pairing with one another or otherwise connecting to establish the communication channel. After the channel is established, however, the tag 108 and mobile device 104 may then authenticate one another and exchange relevant information, such as the key(s), to enable an access control decision to be made, including the use of pace authentication. If a positive access control decision is made (e.g., it is determined that the key(s) are valid and the mobile device 104 is allowed to access the asset protected by the tag 108), then the tag 108 may initiate one or more actions to enable the holder/user of the mobile device 104 to access the asset protected by the tag 108.

The POS terminal 112 may be any terminal useful for processing transactions and communicating with the store backend server 120 regarding the same. The POS terminal 112 may comprise a processor 170, a computer-readable memory 172 or other data storage device (storing, for example, instructions for execution by the processor, inventory information, pricing information), a network communication interface 178 capable of communicating with the store backend server 120 (e.g., via TCP/IP, UDP, RTP, GSM, LTE, Wi-Fi, and/or other network communication protocols), and in some embodiments, a tag communication interface 180 capable of communicating with the tag 108, whether via a wired protocol or a wireless protocol (e.g., using a proximity-based protocol such as any one of the proximity-based protocols identified herein). The POS terminal 112 may also comprise a user input device 174 (e.g., a keyboard, a touchscreen, a bar-code scanner) and an output device 176 (e.g., a display screen, a printer).

In some embodiments, the POS terminal 112 may be a physical sales terminal supporting proprietary software such as the 4690 Operating System, introduced by IBM. Alternatively, the POS terminal 112 may be a physical sales terminal supporting an open standard such as the OLE standard created by Microsoft, NCR Corporation, Epson, and Fujitsu, or the Java for Retail POS.

The POS terminal 112, in some embodiments, is identified by some unique identifier (POS ID) within the payment system corresponding to the store backend server 120. This unique identifier may be a device serial number, or some combination of data, such as information from the Header Lines (for example ContractorID) and the FPTR_MT_CASH_REGISTER_NUMBER in the above open standards. Alternatively, the POS ID could include a simple text description, which may be a concatenation of the above.

The tag 108 is associated with the POS terminal 112. This association may be created by placing the tag 108 within physical proximity (e.g., within a predetermined distance) of the POS terminal 112. The distance may be, for example, a distance over which the tag 108 can communicate with the POS terminal 112 using near field communication or other proximity-based protocols. An association may additionally or alternatively be created by writing the tag 108 with one or more details that describe the POS terminal 112 (e.g., a terminal ID, a location of the POS terminal 112, a retailer that operates the POS terminal 112, a retailer ID, etc.). In some embodiments, the POS terminal 112 comprises the tag 108.

As seen in FIG. 1E, the cloud payment server 116 may include one or more processors 184, a computer-readable memory 186, one or more network interfaces 182, and a power supply 194. If embodied as something other than a server, the cloud payment server 116 may further include user input and/or output devices.

The processor 184 may be similar or identical to processor 150. For instance, the processor 184 may include one or more CPUs, General Processing Units (GPUs), Integrated Circuit (IC) chips, microprocessors, etc. Alternatively, or additionally, the processor 184 may include other hardware components that are capable of executing the instructions stored in memory 186.

The memory 186 may be similar or identical to memory 152. The memory 186 can be configured to store processor-executable instructions in volatile or non-volatile memory devices. The types of instructions that may be stored in memory 186 include, without limitation, instructions data 188, rules data 190, and other data 192.

The network interface(s) 182 may correspond to one or more hardware devices that enable the cloud payment server 116 to communicate with one or more of the mobile device 104, the store backend server 120, and the POS terminal 112. For instance, the network interface(s) 182 may include one or more wired or wireless serial or parallel data ports. As a more specific example, the network interface(s) 182 may include an Ethernet port, a SCSI port, or the like. The network interface(s) 182 may also include drivers for the hardware components thereof.

The power supply 194 may correspond to internal and/or external power supply devices. For instance, the power supply 194 may correspond to a battery pack, capacitive charge device, or the like. Alternatively or additionally, the power supply 194 may correspond to a power adapter that enables the cloud payment server 116 to receive AC power from an external outlet and convert that AC power into DC power or useable power for the components of the cloud payment server 116.

The cloud payment server 116 represents a cloud payment system, which may be linked (at the user's request) to a source of funds provided or otherwise identified by the user (e.g., a bank account, a credit card). The cloud payment server 116 may release funds (or communication an agreement to provide funds) to a third party (e.g. a retailer) via the store backend server 120 when authorized to do so by the user of the mobile device 104.

The store backend server 120 may have the same or a similar physical structure as the cloud payment server 116. The store backend server 120 may form part of a POS processing system in the form of a single backend system that directly communicates with multiple POS terminals (such as and including the POS terminal 112) and is hosted at a central server location for a given retailer. The store backend server 120 may be configured for tracking inventory, purchases, sales, and/or other aspects of a company's business, and may be connected to a bank account or other financial account of the company. The store backend server 120 may be equipped and/or configured, for example, to receive electronically transferred funds as part of a transaction and to electronically transfer those funds to the bank account or other financial account of the company, or to provide instructions to the cloud payment server 116 or to a third party for depositing funds in the bank account or other financial account of the corresponding company. The retailer or other entity hosting or otherwise responsible for the store backend server 120 may have an established relationship with the entity hosting or otherwise responsible for the cloud payment server 116.

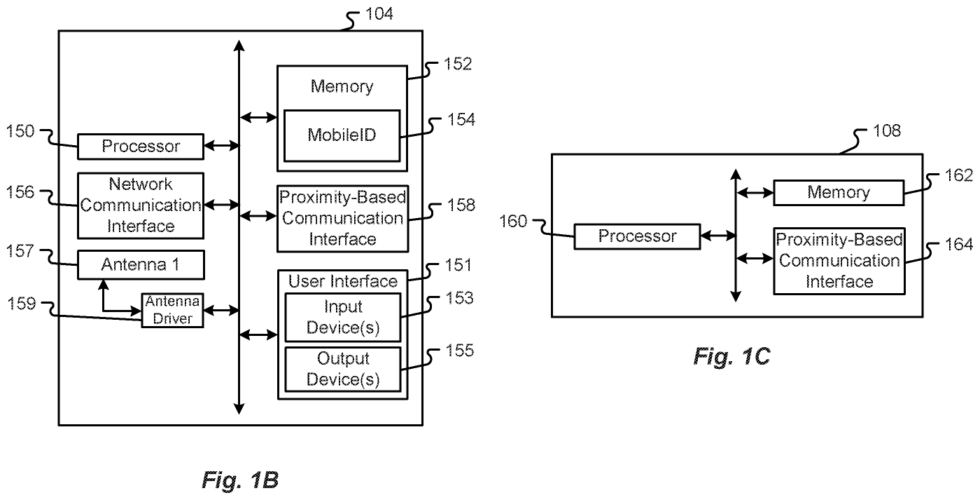

Referring now to FIGS. 1A and 2, a method 200 according to embodiments of the present disclosure comprises a user tapping the mobile device 104 on, or otherwise presenting the mobile device 104 to, the tag 108 (step 204). The tapping action may indicate the user's interest in executing a transaction, and/or the user's intent to initiate an approval process for a purchase transaction occurring at the POS terminal 112, and/or the user's intent to utilize the tap-to-pay system to pay for a transaction. The user may need to approach the tag 108 in order to tap or otherwise present the mobile device 104 on or to the tag 108. In some embodiments, the user of the mobile device 104 may identify himself or herself and/or his or her intent to approve a transaction taking place at the POS terminal 112 (e.g., a sales transaction) when tapping the mobile device 104 on the tag 108. The tapping action can occur substantially simultaneously with the conduct of a transaction at the POS terminal 112, whether immediately before the POS terminal 112 associated with the tag 108 begins processing the transaction, while the POS terminal 112 is processing the transaction, or after the POS terminal 112 has processed the transaction (e.g., if the transaction may be cancelled).

The “tapping” or presenting of the mobile device 104 on/to the tag 108 may comprise the user simply bringing the mobile device 104 within a read range of the tag 108. The read range of the tag 108 may be on the order of ten centimeters or less, which means that the user may need to place the mobile device 104 very near the tag 108, even if the mobile device 104 does not actually contact the tag 108. In other embodiments, where a tag is used that utilizes a protocol having a longer read range than the NFC protocol (e.g., a Bluetooth protocol), the user may be allowed to ‘tap’ the tag as long as the user's mobile device 104 is within a few meters of the tag (or within another distance that falls within the read range of the tag). Regardless of the distance at which the tapping action occurs, the user may need to provide an input on the mobile device 104 (e.g., a fingerprint scan) in order to initiate or cause the tap, and/or to approve the receipt of data from the tag.

As explained in greater detail below, the use of the tag 108 allows a cloud payment system 116 to associate the user/purchaser to the transaction taking place on the POS terminal 112 at, for example, a brick and mortar retailer.

When the user taps the mobile device 104 on the tag 108, the tag 108 may establish a secure communication channel with mobile device 104 (whether using the SEOS® security protocol or another security protocol), and may transmit over the secure communication channel at least some information to the mobile device 104 (step 208). The tag 108 may return identification information corresponding to the tag 108, identification information corresponding to the POS terminal 112 with which the tag 108 is associated, and/or information regarding a current, on-going transaction occurring at the POS terminal 112. In some embodiments, for example, the tag 108 may return a serial number of the tag 108 to the mobile device 104.

As noted above, the tag 108 may be provided with secure programming to help ensure the security of transactions on the POS terminal 112 and to help ensure that the association established between the POS terminal 112 and the tag 108 is secured. Such secure programming may be used, for example, to establish a secure communication channel with a mobile device prior to transmitting information to the mobile device. The tag 108 may be encoded with information related to a transaction in addition to or in lieu of being encoded with information describing the POS terminal 112. In such embodiments, the tag 108 may not necessarily have to be placed within proximity of the POS terminal 112, but rather may be placed within proximity of a particular product or service being offered for sale.

The mobile device 104 initiates the transaction approval process by connecting with a cloud payment system 116 (step 212). The mobile device 104 may send to the cloud payment system 116 a TagID, a POS ID, and/or other information obtained from the tag 108; a mobileID; and/or geolocation information from the mobile device 104. With the TagID, POS ID, mobileID, and/or other information from the mobile device 104, the cloud payment server 116 makes the association between the tag 108 and the POS terminal 112 and identifies the target POS terminal 112. To make this association, the cloud payment server 116 may use some or all of the information received from the mobile device 104 as an input to search a database accessible to the cloud payment server 116 that stores information about tags 108 and/or POS terminals 112. Additional information useful to the cloud payment server 116, such as how to route messages to the POS terminal 112, the geolocation of the tag 108, and the geolocation of the POS terminal 112, could also be stored in a database system accessible to the cloud payment server 116.

In some embodiments, the cloud payment server 116 associates the TagID and/or POS ID with the POS terminal 112. However, the association between the two system components could be made by the mobile device 104, within the cloud payment system corresponding to the cloud payment server 116, within the POS system corresponding to the store backend server 120, and/or at the POS terminal 112 itself.

At this point, the cloud payment server 116 is able to verify: (1) that the user is in possession of the mobile device 104 and (where the mobile device 104 transmits geolocation information to the cloud payment server 116) that this mobile device 104 has geolocation information that can be cross checked with the known location of the tag 108; (2) that the user has physically approached the “Tap-to-Pay” tag 108 to indicate the user's willingness to authorize a transaction; and (3) that the user has an identity known to the cloud payment server 116 (e.g., the user is pre-vetted by virtue of having an account with the cloud payment system represented by the cloud payment server 116).

In this and other methods described herein, communications between any two components of a system (e.g., between a mobile device 104 and a cloud payment server 116, between a cloud payment server 116 and a store backend server 120, between a store backend server 120 and a POS terminal 112) may take place over a secure communication channel. The secure communication channel may be secured at least in part, for example, by the use of keys. Any methods known in the art for securing electronic communications may also be used to establish a secure communications channel within the scope of the present disclosure.

Upon receipt of data from the mobile device 104, the cloud payment server 116 signals to the store backend server 120 that a user has signaled an intent to pay for a transaction (step 216). The cloud payment server 116 provides to the store backend server 120 at least some of the following information: (1) the TagID and/or POS ID data received from the tag 108; (2) an identifier assigned to the mobile device 104; (3) an identifier of the mobile payments application operating on the mobile device 104; and (4) the mobileID of the user.

In a usual transaction scenario, the store backend server 120 is informed that a payment authentication request has been initiated by the user of the mobile device 104. Alternatively, the cloud payment server 116 could have direct communications with the POS terminal 112, without any intermediary backend system. Optionally, the cloud payment server 116 may provide the store backend server 120 with information to identify the user of the mobile device 104 to provide some advantage to the user (e.g., coupon management), or simply provide attributes about the user for the benefit of the retail organization (such as understanding the retail organization's customer base for advertising).

To preserve the user's privacy, and to safeguard the user's personal data, the cloud payment server 116 may create a second user identity, mobileID2, that cannot be correlated to the actual user using any public database. This mobileID2 may be relevant and linked to the mobileID for the user at least for this single transaction. In such an embodiment, the cloud payment server 116 acts as an anonymous broker for the user to the store backend server 120.

The store backend server 120 forwards some or all of the information received from the cloud payment server 120 to the correct store (where the store backend server 120 services a plurality of stores) and further on to the correct POS terminal 112 at the checkout lane in which the user is situated (step 220), thus indicating that the user intends to pay for the transaction using the mobile device 104 (e.g., with a mobile payments application running on the mobile device 104). This could lead to a notification displayed on the screen of the POS terminal 112 (or otherwise presented via an output 176 of the POS terminal 112) to an operator of the POS terminal 112, indicating the user's intention to use tap-to-pay for the transaction.

The store backend server 120 may leverage the TagID and/or POS ID information to identify the POS terminal 112 so as to be able to communicate to the POS terminal 112 the user's intent to pay, and to request the transaction details from the POS terminal 112. The cloud payment server 116 may provide limited routing information when signaling the user's intent to pay to the store backend server 120, which limited routing information may merely route the message to the appropriate store backend server 120. The specific device for the transaction (e.g., POS terminal 112) may be provided and/or determined by the store backend server 120 based upon receiving the TagID and/or POS ID data from the cloud payment server 116.

The POS terminal 112 sends the transaction details to the store backend server 120 (step 224). The POS terminal 112 may provide the transaction details to the store backend server 120 in real time or after the transaction is totaled. Transaction details may include transaction context data (e.g., transaction date, transaction time, location of purchase, etc.) as well as detailed information about what is being purchased (e.g., item identifier, number of items, cost of items, currency used, etc.).

The store backend server 120 sends the transaction details to the cloud payment server 116 (step 228). The store backend server 120 may send the transaction details to the cloud payment server 116 together with the TagID and/or POS ID specifics, or within an existing stream used to communicate with the cloud payment server 116.

The cloud payment server 116 matches the received transaction details with a mobileID user registered in its cloud payment system. Using this information, the cloud payment server 116 may locate a phone number or communication target information (e.g., IP address, MAC address, device ID) and send an approval request to the user (step 232). This approval request triggers an application on the user's device, which may or may not be, or be similar to, the HID® Approve™ or another HID® mobile push authentication application. The application provides the details of the transaction (e.g., what is being purchased, what are the costs, and so forth) to the user (e.g., via a screen of the mobile device 104) and asks the user to authenticate the transaction.

If the user is agreeable to the transaction details and approves the transaction, then the mobile device 104 transmits payment approval to the cloud payment server 116 (step 236). The user may have the ability to provide line-by-line approval for each item in the transaction, or the user may be presented only with options to approve or deny the entire transaction.

In some embodiments, the approval step may utilize HID® Approve™, described at https://www.hidglobal.com/sites/default/files/resource files/hid-approve-ds-en_1.pdf, the entire contents of which are hereby incorporated herein by reference. HID® Approve™ is a next-generation two-factor authentication solution. By combining public key-based cryptography with mobile push notifications, HID® Approve™ delivers a simple and secure way for users to authenticate and verify their transactions. With a simple swipe gesture (e.g., swiping an “approve” button from one side of a screen of the mobile device 104 to the other), proof-of-possession for ‘something a user has’ is obtained to achieve strong two-factor authentication. Security features similar to those provided by the HID® Approve™ application may be incorporated into an application on the mobile device 104 that is triggered by the approval request.

Before the user even sees a request to approve a transaction on the mobile device 104, the mobile payments application on the user's mobile device 104 may authenticate the user with biometric matching such as facial recognition, fingerprint recognition, and/or iris recognition. When the user approves the transaction (whether by selecting “Approve” in the HID® Approve™ application by swiping a button from left to right, or by any other manner) the mobile phone 104 and/or the cloud payment server 116 could further authenticate the user's fingerprint.

In a non-limiting example, the Tag ID and/or POS ID could be accompanied by a unique value, similar to a one-time password sequence value, that is computed by the tag 108 based on parameters located prior to the purchase transaction. This one-time password sequence value could be computed at the cloud payment server 116, store backend server 120, or POS terminal 112. It could be verified separately by the cloud payment server 116, store backend server 120, or a POS terminal 112. Subsequent taps of the mobile device 104 to the tag 108 could invalidate previous transaction requests. Thus, if a user is viewing an order, and erroneously taps the mobile device 104 on the tag 108 a second time, the POS terminal 112 may retain the list of items to order, but invalidate the previous ‘transaction,’ and instead start a new transaction with a new one-time password value to use with the order.

Upon receipt of the user's approval to complete the transaction, the cloud payment server 116, having authenticated the user's credentials, forwards the payment authentication details to the store backend server 120 (step 240), which notifies the POS terminal 112 that payment has been received (step 244), thus enabling the POS terminal 112 to complete the transaction. Alternatively or additionally, the transaction may be completed at the cloud payment server 116, and the store backend server 120 may simply be informed of the completed transaction and provided with a payment receipt for its records.

In some embodiments, a mobile payments application running on the mobile device 104 displays the provided transaction details for the user to view and based upon which to make a decision regarding whether to accept the transaction and provide the okay for a payment to be made. If and when the user approves the transaction by selecting a “Pay” button or by otherwise indicating the user's approval of the transaction, the approval is transmitted to the cloud payment server 116.

Alternatively or additionally, the cloud payment server 116 makes the payment for the transaction at the identified POS terminal 112 pursuant to an agreement with the retailer store. Thereafter, the POS terminal 112 sends the information to the store backend server 120 that a payment has been received, and the transaction is completed in the standard method where a receipt is provided to the user indicating that payment for the transaction at the POS terminal 112 has been received.

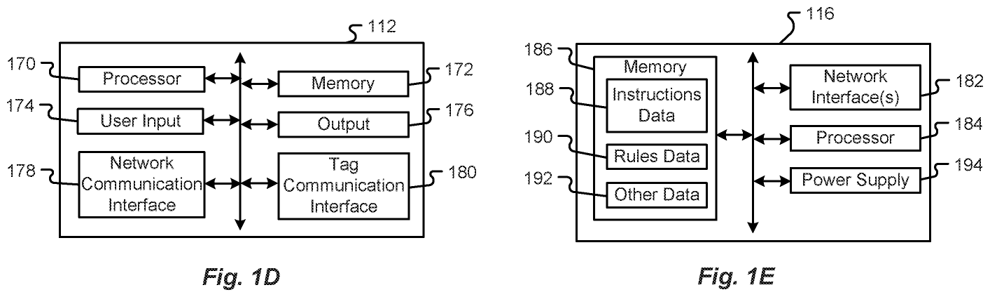

Referring now to FIG. 3, a system 300 according to an embodiment of the present disclosure comprises a mobile device 104 and a cloud payment server 116. The system 300 further comprises a mobile merchant (e.g., a person or other entity processing transactions with a mobile device 304) utilizing a tag 108. In this embodiment, the concept of a traditional POS terminal such as the POS terminal 112 is replaced with the mobile merchant's mobile device 304. The mobile device 304 may be identical to or substantially the same as the mobile device 104. The tag 108 may be attached to the mobile merchant's mobile device 304 or placed in proximity thereto. The tag 108 may further be encoded with information associated with or describing the merchant's mobile device 304 and/or the mobile merchant.

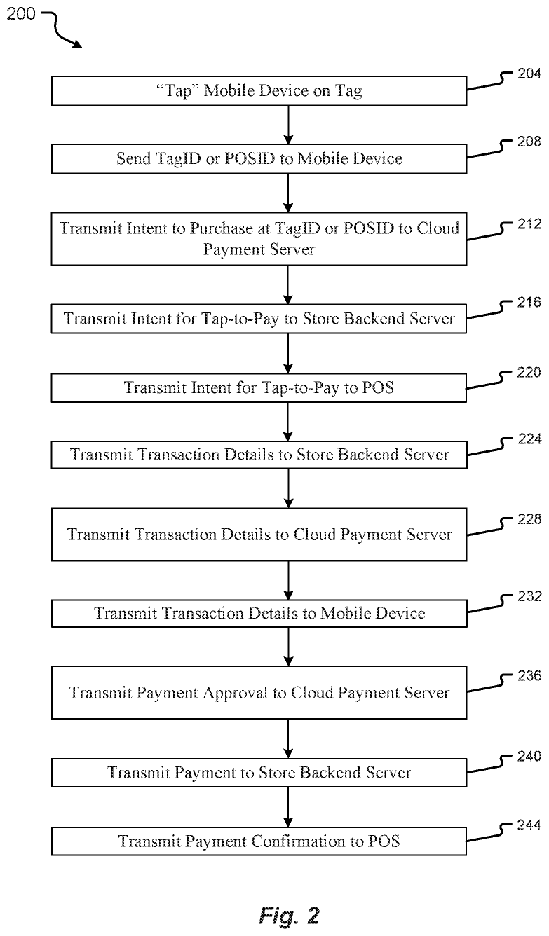

Referring now to FIGS. 3 and 4, a method 400 comprises tapping the mobile device 104 on the tag 108 (step 404) to initiate a payment transaction. In response to the tapping of the mobile device 104 on the tag 108, the flow of information may commence with the transmission to the mobile device 104 by the tag 108 of a TagID, a POS ID (which in this embodiment describes the mobile device 304 rather than a POS terminal 112), other identification information corresponding to the tag 108 or the mobile device 304, and/or information regarding a current, on-going transaction occurring at the mobile device 304 (step 408). In some embodiments, for example, the tag 108 may return a serial number of the tag 108 to the mobile device 104.

The user's mobile device 104 may communicate information to a cloud payment server 116 that indicates the user's intent to purchase from the mobile merchant along with some or all of the identification information obtained from the tag 108 (step 412). Alternatively, the transaction may initiate with a communication between the mobile merchant's mobile device 304 and the user's mobile device 104. In this scenario the same information that would normally be sent via the tag 108 (e.g., TagID and/or POS ID) would be sent from the mobile merchant's mobile device 304 to the mobile device 104. In such embodiments, rather than the user of the mobile device 104 providing information to the merchant, the merchant shares information to identify a transaction directly with the mobile device 104 of the user, who has an established trusted relationship with the cloud payment system represented by the cloud payment server 116.

The cloud payment server 116 transmits an indication of the user's intent for tap-to-pay to the mobile merchant's mobile device 304 (step 416). The cloud payment server 116 may provide to the mobile device 304 of the mobile merchant at least some of the following information: (1) the TagID and/or POS ID data received from the tag 108; (2) an identifier assigned to the mobile device 104; (3) an identifier of the mobile payments application operating on the mobile device 104; and (4) the mobileID of the user.

Optionally, the cloud payment server 116 may provide the mobile device 304 with information to identify the user of the mobile device 104 to provide some advantage to the user (e.g., coupon management), or simply to provide attributes about the user for the benefit of the mobile merchant (such as understanding the mobile merchant's customer base for advertising). On the other hand, to preserve the user's privacy, and to safeguard the user's personal data, the cloud payment server 116 may create a second user identity, mobileID2, that cannot be correlated to the actual user using any public database. This mobileID2 may be relevant and linked to the mobileID for the user at least for this single transaction. In such an embodiment, the cloud payment server 116 acts as an anonymous broker for the user to the mobile merchant.

The mobile device 304 of the mobile merchant sends the transaction details to the cloud payment server 116 (step 420). The mobile device 304 may provide the transaction details to the cloud payment server 116 in real time or after the transaction is totaled. Transaction details may include transaction context data (e.g., transaction date, transaction time, location of purchase, etc.) as well as detailed information about what is being purchased (e.g., item identifier, number of items, cost of items, currency used, etc.).

The cloud payment server 116 sends the transaction details to the mobile device 104, together with an approval request (step 424). If the user is agreeable to the transaction details and approves the transaction, then the mobile device 104 transmits payment approval to the cloud payment server 116 (step 428).

Upon receipt of the user's approval to complete the transaction, the cloud payment server 116, having authenticated the user's credentials, forwards the payment authentication details to the mobile merchant's mobile device 304 (step 432), thus enabling the mobile device 304 to complete the transaction. Alternatively or additionally, the transaction may be completed at the cloud payment server 116, and the mobile device 304 may simply be informed of the completed transaction and provided with a payment receipt for its records.

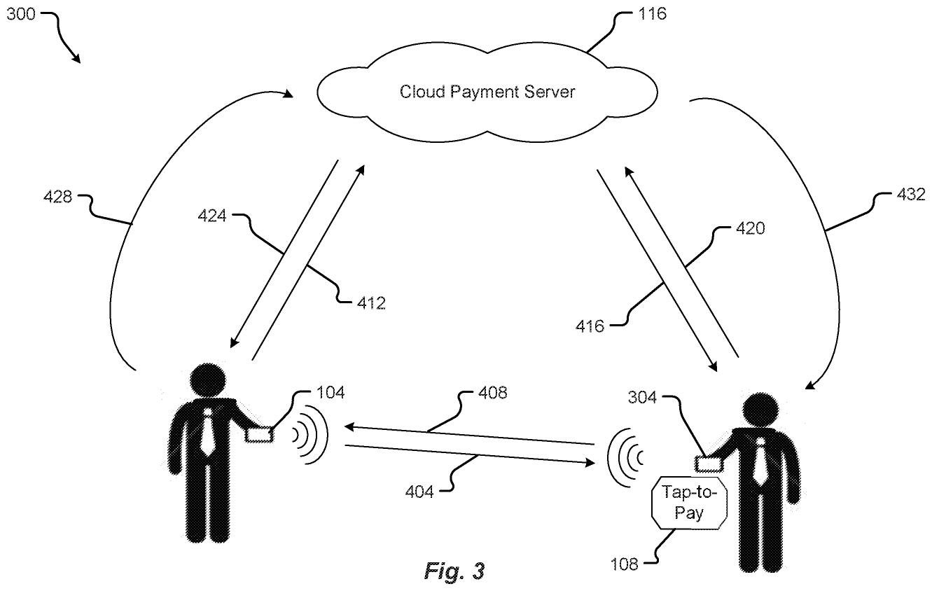

With respect to FIG. 5, in a system 500 according to embodiments of the present disclosure, a tag 108 is situated near a place of order 504 or place of pickup 508 at a drive thru retailer (e.g., a fast food establishment). In some embodiments, one or multiple tags 108 may be situated around a drive thru retailer's premises and the user may be allowed to “tap” one or all of the tags 108 to facilitate a transaction. This embodiment is more secure than traditional methods of mobile payment whereby the teller at the drive thru pickup window takes momentary possession of the purchaser's credit card, or extends a POS terminal such as the POS terminal 112 (or a dongle attached thereto) outside of the establishment's building window. In this embodiment, the user taps the mobile device 104 to a tag 108 that is within proximity of the drive thru line and accessible to the user via the window of the user's vehicle.

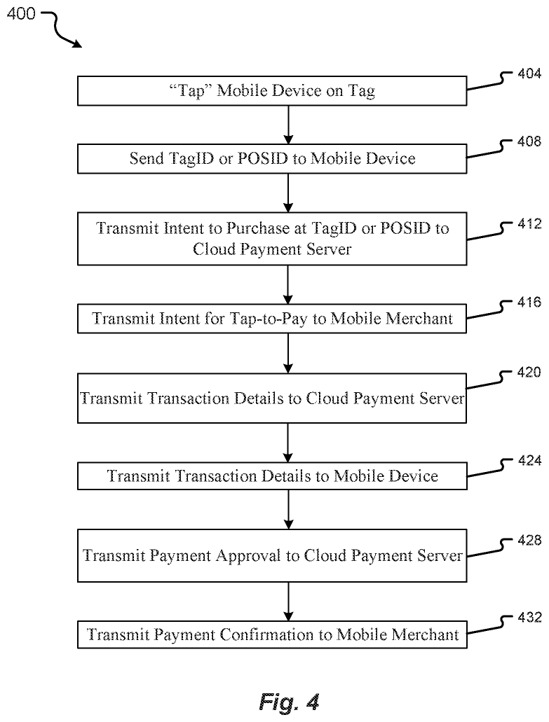

With respect to FIGS. 5-6, the flow of information through the system 500 as presented in the method 600 may be substantially similar if not identical to that described above in connection with the method 200, except that store or drive thru lane information may also be encoded on the tag 108 and shared to the mobile device 104 (which is subsequently shared to cloud payment server 116 and the store backend server 120). Thus, each of the steps 604, 608, 612, 616, 620, 624, 628, 632, 636, 640, and 644 may be the same as or substantially similar to the steps 204, 208, 212, 216, 220, 224, 228, 232, 236, 240, and 244, respectively.

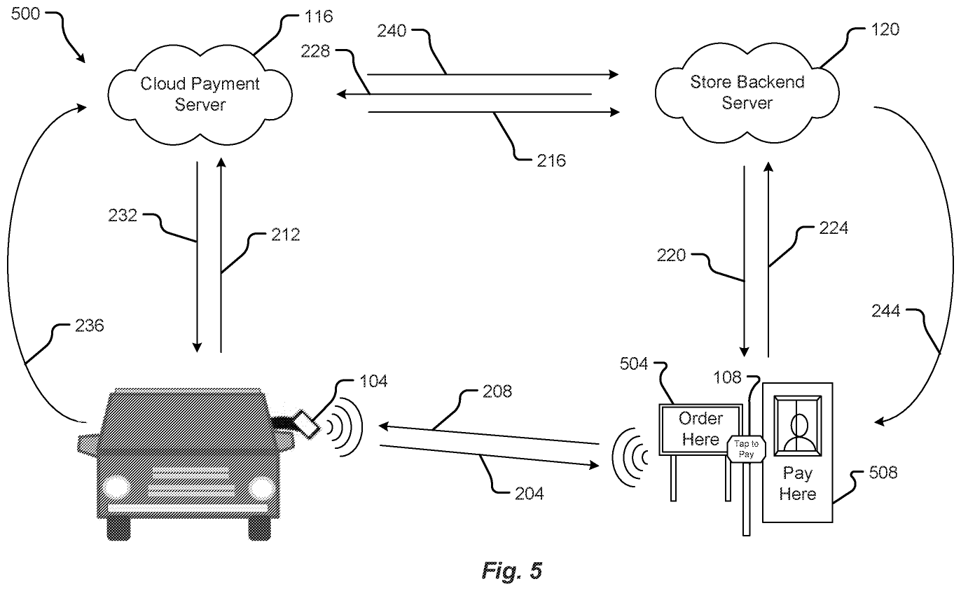

Turning now to FIG. 7, a system 700 according to embodiments of the present disclosure comprises a single line or payment queue that may be equipped with a plurality of tags. More specifically, a conveyor belt 704 is equipped with multiple tags 708a, 708b, 708c, 708d, 708e, 708f. (Each tag 708a, 708b, 708c, 708d, 708e, 708f may be the same as or substantially identical to the tag 108.) This enables a user standing in line to tap the tag 708a, 708b, 708c, 708d, 708e, or 708f nearest to the user's current position with the user's mobile device 104. Each tag 708a, 708b, 708c, 708d, 708e, 708f may be encoded with different position information to help describe that tag's relative position with respect to the “head of the line.” Thus, a first user closer to the head of the line (and therefor closer to the physical POS terminal 720, which may be the same as or similar to the POS terminals 112 described elsewhere herein) may tap a first tag 708a or 708b, whereas a second user that is behind the first user may tap a second tag that indicates the second user is further away from the POS terminal 720. A separator 712 may be used to physically separate the goods 716 to be purchased by one user from the goods 716 to be purchased by another user.

When a user taps on a tag 708a, 708b, 708c, 708d, 708e, 708f, the tag may transmit a TagID, POS ID, queue position/location information, and/or other information (including any information described herein as being communicated by a tag 108 to a mobile device 104) to the mobile device 104. Each user's mobile device 104 may share the appropriate TagID, POS ID, and/or queue position/location information with the cloud payment server 116. The cloud payment server 116 may correlate the queue position/location information with a specific place in line, or simply share that information to the store backend server 120 to help maintain an order of transactions at a particular POS terminal 720. As a non-limiting example, a user at the back of the line may be able to begin initiating a transaction by tapping the tag 708a, 708b, 708c, 708d, 708e, or 708f further away from the POS terminal 720, thereby saving transaction time when the user finally gets to the head of the line.

In some embodiments, a user who taps, with the user's mobile device 104, a tag 708a on the conveyer belt 704 may be indicating the user will pay for goods 716 up to and until the separator 712. Additionally, this user may tap the mobile device 104 a second time on the tag 708b just ahead of the separator 712 to indicate that none of the user's goods 716 are located after that point on the conveyor belt 704. Alternatively, a user may indicate that he or she will pay for all items following the separator 712 by tapping the tag 708c physically attached to the conveyor belt 704 behind the separator 712. The system 700 may be used in methods such as the methods 200 and 600, with the tags 708a, 708b, 708c, 708d, 708e, and 708f replacing the tag 108 in those methods, and the POS terminal 720 replacing the POS terminal 112 in those methods.

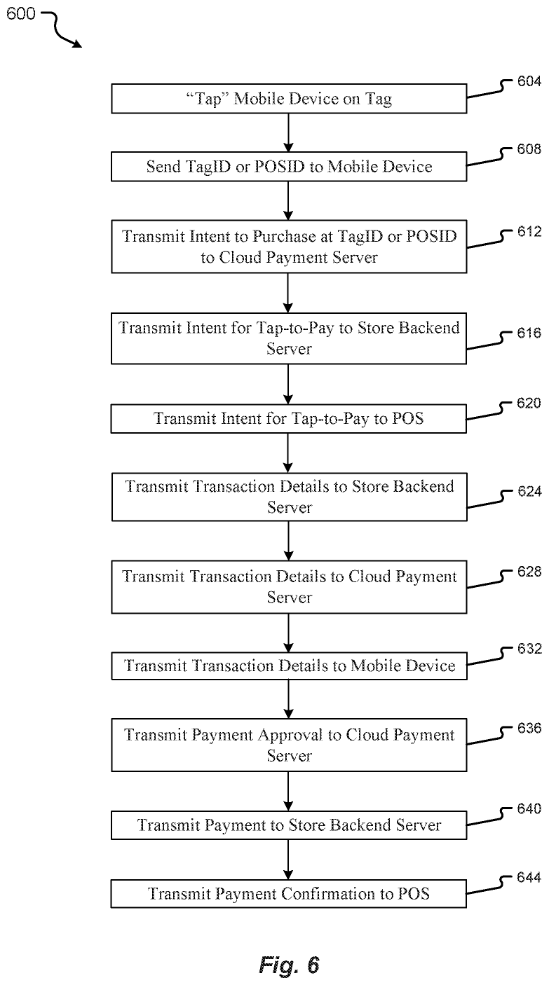

FIG. 8 illustrates a system 800 according to embodiments of the present disclosure that is useful for receiving and/or redeeming mobile coupons. Mobile coupons could be for products, services, and/or discounts, and may be available through or importable to, for example, a mobile payments application running on the mobile device 104 of the user, or may be available from the cloud (whether from the cloud payment server 116, from the store backend server 120, or from a third party).

In some embodiments, mobile coupons could be shared using information received from the tag 108 as a trigger. As a non-limiting example, mobile coupons received from the cloud payment server 116 may be triggered when the user taps the tag 108 associated with the POS terminal 112 and receives the POS ID.

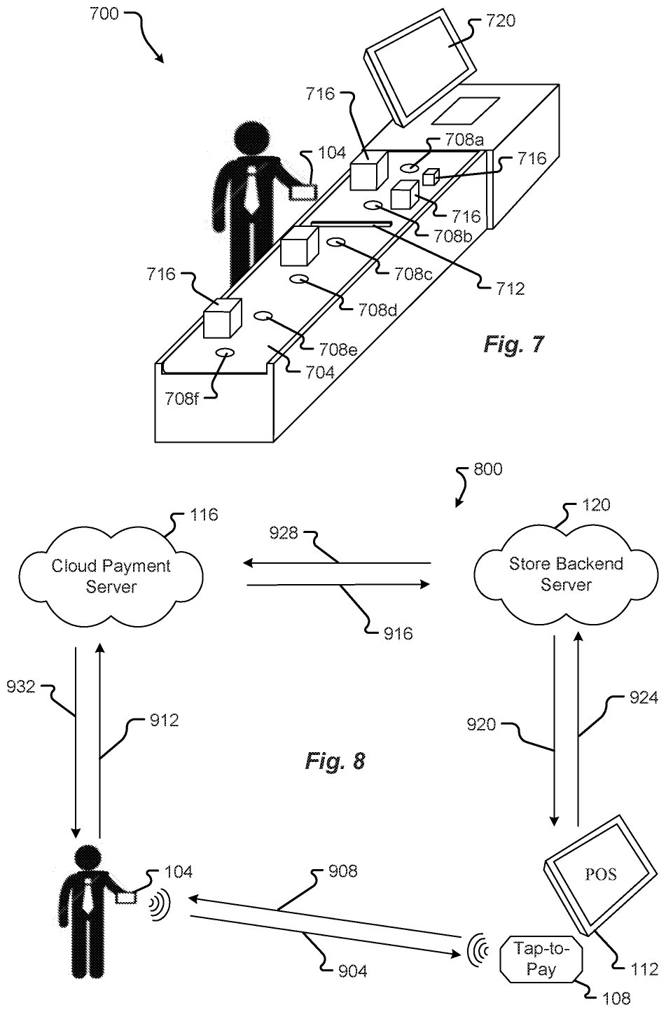

With reference to FIGS. 8-9, a user 104 may indicate an intent to initiate a payment transaction by tapping the mobile device 104 on the tag 108 (step 904). The tag 108 may transmit a TagID, a POS ID, and/or other information as described herein to the mobile device 104 (step 908). Steps 904 and 908 may be the same as or substantially similar to, for example, steps 204 and 208 of the method 200.

The user may indicate which mobile coupons he or she would like to have applied to the initiated transaction (whether before or after tapping the mobile device 104 to the tag 108) or mobile coupons may be applied automatically (e.g., in the case of loyalty discount points).

A mobile coupon application, mobile payments application, or application running on the mobile device 104 may cause the mobile device 104 to provide the POS ID of the POS terminal 112 to the cloud payment server 116 (step 912) in order for selected mobile coupons to be applied, if available. Other information received by the mobile device 104 from the tag 108 may also be transmitted to the cloud payment server 116. The cloud payment server 116 forwards any applicable coupon identifiers to the store backend server 120 (step 916).

The store backend server 120 forwards the coupon identifiers to the POS terminal 112 to be applied to the current transaction (step 920). The POS terminal 112 applies the applicable mobile coupons to the transaction, and the transaction details reflecting application of the mobile coupon(s) are sent from the POS terminal 112 back to the store backend server 120 (step 924).

The store backend server 120 transmits the transaction details to the cloud payment server 116 (step 928). The cloud payment server 116 forwards the transaction details reflecting application of the applicable mobile coupons to the transaction to the mobile device 104, where the user of the mobile device 104 may review the same using an application running thereon (step 932). In step 932, the cloud payment server 116 may also transmit a request for approval to make a payment to the mobile device 104.

When the transaction is tabulated, the coupon details will have been applied within the purchase items and purchase amount.

Remaining steps involving the user's review of the transaction details and the payment approval process may be the same as or substantially similar to steps 236, 240, and 244 of the method 200.

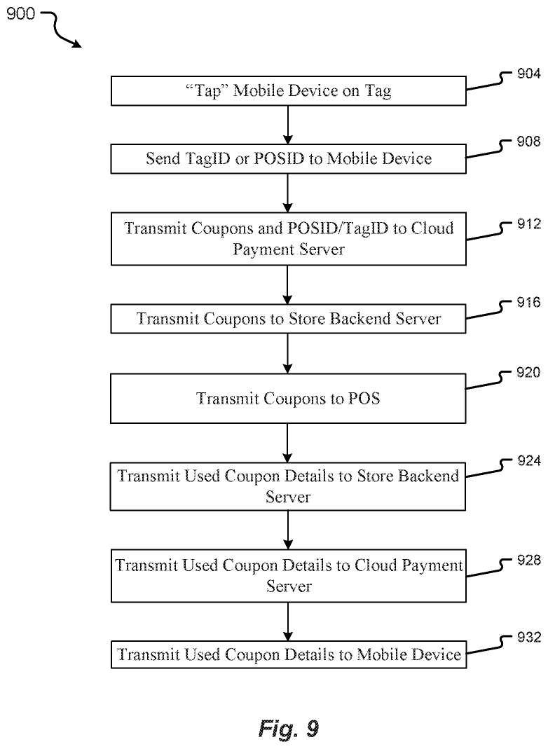

Turning to FIG. 10, a system 1000 according to embodiments of the present disclosure utilizes a POS terminal 112 equipped with a Bluetooth low energy (BLE) receiver 1024, as well as other components discussed above including a mobile device 104, a tag 108 associated with the POS terminal 112, a cloud payment server 116, and a store backend server 120. The BLE receiver 1024 is capable of direct communication with the mobile device 104. In some embodiments, a receiver comprising a communication interface for communicating using a protocol other than BLE may be used instead of the BLE receiver 1024. For example, such a receiver may be equipped to communicate using TCP/IP, UDP, RTP, GSM, LTE, Wi-Fi, and/or other network communication protocols, and/or using infrared, ultrasonic, IEEE 802.11N, and/or other proximity-based communication protocols.

In the system 1024, which may in some embodiments be utilized in the same manner as the system 800, mobile coupons can also be sent from the mobile device 104 (e.g., based on one or more instructions corresponding to an application running on the mobile device 104) directly to the POS terminal 112 via the BLE receiver 1024.

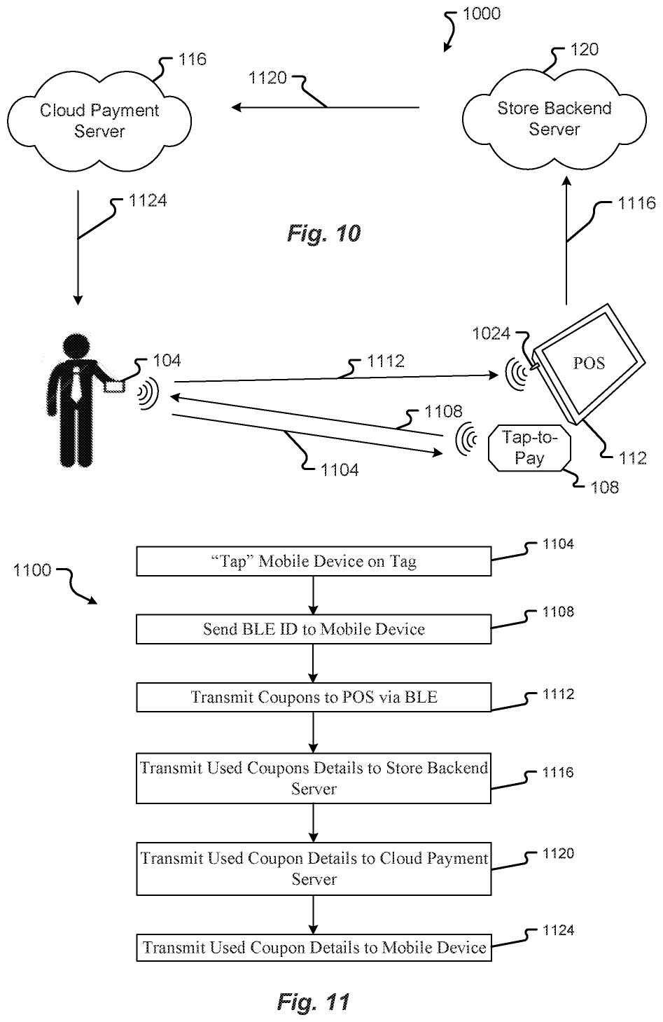

Referring now to FIGS. 10-11, a method 1100 of utilizing the system 1000 comprises tapping the mobile device 104 on the tag 108 (step 1104), and transmitting, from the tag 108 to the mobile device 104, at least a BLE identifier (BLE ID) (step 1108). The BLE identifier is the receiver ID of the BLE receiver 1024 that is plugged into the POS terminal 112.

Once the mobile payments application running on the mobile device 104 has received the BLE ID, the application sends the user's mobile coupons directly to the POS terminal 112 (e.g., without passing through any intermediary devices) via BLE (step 1112). The POS terminal 112 receives the mobile coupon information and applies the coupon information to the current transaction.

The POS terminal 112 sends the used coupon details (and, in some embodiments, other transaction details as described elsewhere herein) to the store backend server 120 (step 1116). The store backend server 120 sends the used coupon details (and, in some embodiments, other transaction details as described elsewhere herein) to the cloud payment server 116 (step 1120). The cloud payment server 116 sends the used coupon details (and, in some embodiments, other transaction details as described elsewhere herein) to the mobile device 104 (step 1124). Alternatively, the coupon details (and, in some embodiments, other transaction details as described elsewhere herein) could be sent directly from the POS terminal 112 to the mobile device 104 via BLE.

When the transaction is tabulated, the coupon details will have been applied within the purchase items and purchase amount. The user of the mobile device 104 may then be asked to approve payment, which approval and subsequent communications may occur, by way of example only, in any of the ways described elsewhere herein.

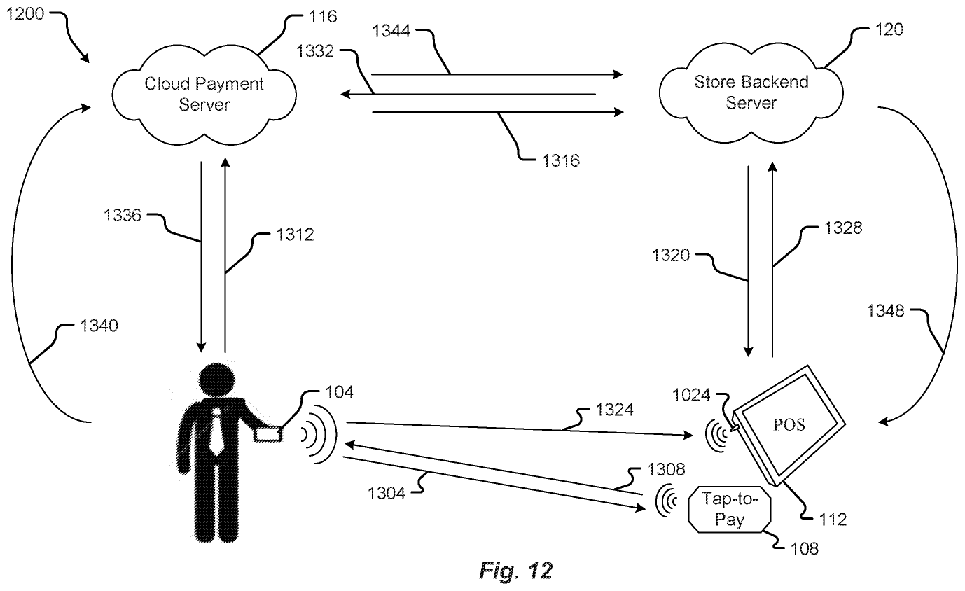

With reference to FIG. 12, in a system 1200 according to embodiments of the present disclosure, a mobile payment and mobile coupons can be available both from the cloud and via BLE, and both may be applied to the same transaction. The system 1200 is substantially similar, if not identical, to the system 1000, and includes a mobile device 104, a POS terminal 112 having a BLE receiver 1024, a tag 108 associated with the POS terminal 112, a cloud payment server 116, and a store backend server 120. Each of these components has been previously described above.

As can be appreciated, one of the existing problems with mobile wallets relates to the timing of when coupons are provided to a POS terminal 112 from the mobile wallet. In prior art systems, the transaction is rung up and then the mobile wallet is presented to the POS terminal. If there are any coupons available on the mobile wallet for the transaction, those coupons are transmitted at this time. In accordance with embodiments of the present disclosure, coupons can be sent in advance of or in conjunction with the ringing up of items at the POS terminal 112 (e.g., because the transaction is initiated by the user tapping the mobile device 104 to the tag). This enables the POS terminal 112 to generate a bill that reflects the exact amount that should be paid when viewed by the consumer rather than leaving into question whether or not a particular coupon has been applied to a transaction.

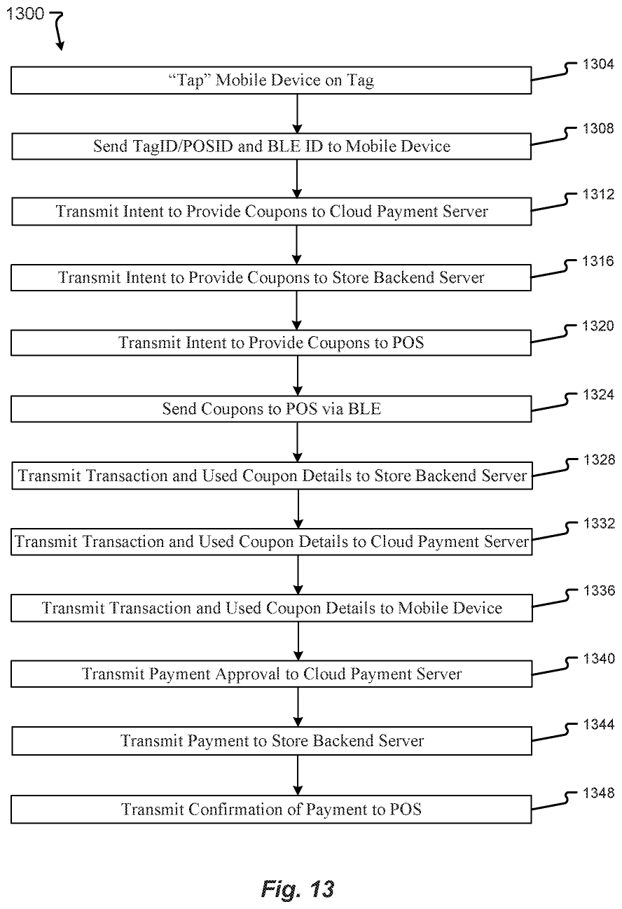

As illustrated in FIGS. 12-13, a method 1300 of utilizing the system 1200 comprises tapping the mobile device 104 on the tag 108 (step 1304), and receiving from the tag 108 a TagID, POS ID, BLE ID, and/or other information at the mobile device 104 from the tag 108 (step 1308). The mobile device 104 transmits the user's intent to provide coupons to the cloud payment server 116 (step 1312). The cloud payment server 116 transmits the user's intent to provide coupons to the store backend server 120 (step 1316), and the store backend server 120 transmits the user's intent to provide coupons to the POS terminal 112 (step 1320). The mobile device 104 transmits the mobile coupons directly to the POS terminal 112 via the BLE receiver 1024 (step 1324). The POS terminal 112 submits transaction details and used coupon details to the store backend server 120 (step 1328), which transmits the transaction details and used coupon details to the cloud payment server 116 (step 1332). The cloud payment server 116 sends the transaction details and used coupon details to the mobile device 104 (step 1336), which may trigger a mobile payments application or other application running on the mobile device 104 to prompt the user of the mobile device 104 to approve or disapprove payment for the transaction in question. If the user approves payment for the transaction, the mobile device 104 transmits the payment approval to the cloud payment server 116 (step 1340), which transmits payment to the store backend server 120 (step 1344). The store backend server 120 notifies the POS terminal 112 that payment has been received (step 1348).

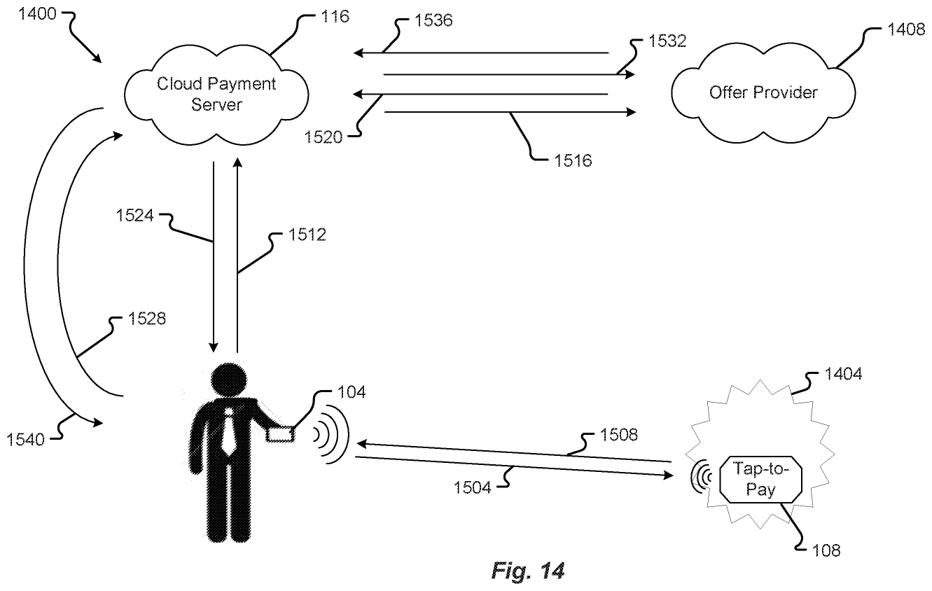

In some embodiments of the present disclosure, a tag may be associated with some type of offer for a specific service or product as opposed to being associated with a physical POS terminal. FIG. 14 illustrates a system 1400 of the present disclosure, in which there is no physical POS terminal (e.g., no POS terminal 112, in contrast to other systems described herein). The system 1400 comprises a mobile device 104, a cloud payment server 116, an offer provider 1408, and an offer promotion 1404 associated with a tag 108. The system 1400 may be used to enable a mobile payment to be made in response to or otherwise in correlation with a promoted offer.

The offer provider 1408 may be a cloud-based server or other network-accessible computer system hosted by or otherwise corresponding to an individual or entity promoting the offer described or otherwise referenced on the offer promotion 1404. There may be an established relationship between the individual or other entity promoting the offer corresponding to the offer promotion 1404 and the individual or entity hosting or otherwise responsible for the cloud payment server 116.

The offer promotion 1404 has known attributes, and may have human-readable attributes which provide at least some information to a user about an offer promoted thereby. The offer promotion 1404 may have incomplete details about the offer, but a consumer or other user of the mobile device 104 may obtain complete offer details by, for example, tapping the mobile device 104 to the tag 108. The tag 108 may comprise an offer identifier, which may be a unique ID that corresponds to a specific set of attributes describing the offer. In some embodiments, the offer identifier may be or comprise a website address that, when accessed, provides current offer details. Alternatively or additionally, the offer identifier could include a data set that corresponds to a data scheme that self-describes the offer promoted by the offer promotion 1404. In any case, the offer identifier may correspond to the specifics of the offer details available from the offer provider 1408.

The attributes of the offer corresponding to the offer promotion 1404 may be fixed. Alternatively, such attributes may be dynamic, and correspond to changing information regarding the offer definition. Variables that may be associated with changes in the offer include, but are not limited to, product type, service, price, location, quantity, level of service, vendor, when a product or service may be available, and/or how the product or service may be delivered or provided. The human readable information contained on the offer promotion 1404 regarding the attributes of the offer may also be fixed or variable. For example, the offer promotion 1404 could comprise a digital promotional display screen, with information displayed thereon that changes to reflect changes in the corresponding offer or to reflect one or more different offers. In some embodiments, the details of an offer that is the subject of an offer promotion 1404 could be fixed or dynamic. For example, the details of an offer for seats in a concert venue may change as seats in the concert venue are sold in real time. In such an embodiment, the human readable information on the offer promotion 1404 may be fixed, but “best available” seat information or other offer attributes provided after the user of the mobile device 104 taps the tag 108 with the mobile device 104 may change between transactions or even, in some embodiments, during a transaction.

The act of tapping the tag 108 with the mobile device 104 turns the offer into a specific transaction, or more precisely, initiates a specific transaction. The user of the mobile device 104 does not have to complete the transaction if the user loses interest in the offer after seeing the complete offer details.

The initiation of a specific transaction in response to the tapping of the tag 108 with the mobile device 104 comes with all of the protections that normally accompany a transaction. For example, if an offer corresponds to the purchase of a hotel room, the act of tapping starts a transaction and a room set aside for the offer is taken out of the available inventory (at least temporarily, e.g., until the transaction is complete) that might be offered to others who wish to purchase this limited resource.

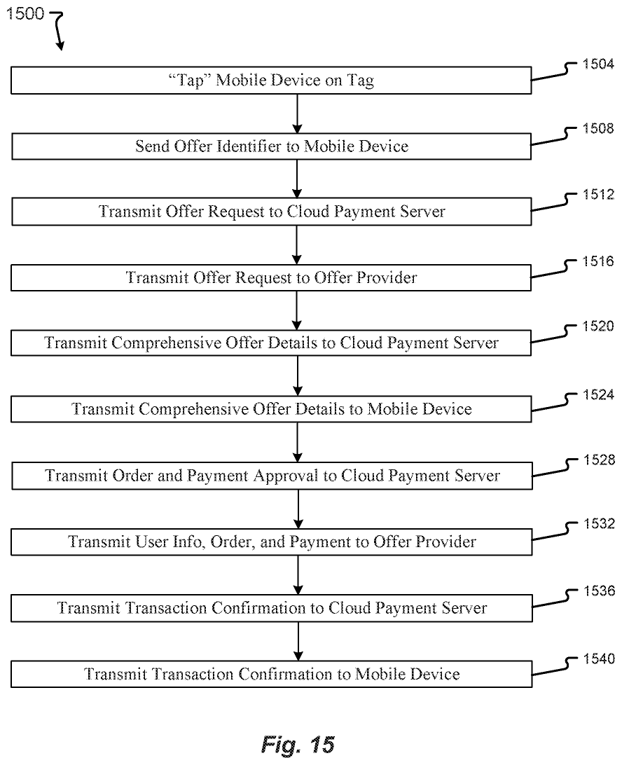

Referring now to FIGS. 14-15, a method 1500 of using the system 1400 comprises initiating a mobile payment order or transaction for a promoted offer by tapping the mobile device 104 on the tag 108 associated with the offer promotion 1404 (step 1504).

The tag transmits the current offer identifier information to the mobile device 104 (and, in some embodiments, to a mobile payments application running on the mobile device 104) (step 1508). In some embodiments, the user of the mobile device 104 may be able to qualify or update certain attributes of the offer from the mobile device 104, whether using a mobile payments application or another application, after receiving the offer identifier. For example, the user may be able to select one of two alternative offers to pursue, or to select between or among some other set of choices associated with the offer.

The mobile device 104 sends the offer identifier and, in some embodiments, information about the user of the mobile device 104 (or the person pursuing the offer, if not the user of the mobile device 104) to the cloud payment server 116 (step 1512). The cloud payment server 116 forwards some or all of the received information, including the offer identifier, to the offer provider 1408 (step 1516). The Offer provider 1408 responds by sending comprehensive offer details to the cloud payment server 116 (step 1520), which in turn transmits the comprehensive offer details to the mobile device 104 (step 1524). The user of the mobile device may then review the comprehensive offer details on the mobile device 104, whether via a mobile payments application on the mobile device 104 or otherwise.

If the user of the mobile device 104 inputs an intent to accept the offer after receiving the comprehensive offer details, then the mobile device 104 transmits an offer order and/or payment approval to the cloud payment server 116 (step 1528). The cloud payment server 116 sends any needed information about the user of the mobile device 104 or other person accepting the offer through the mobile device 104 (to the extent not already provided to the offer provider 1408), the offer order, and/or payment approval to the offer provider 1408 (step 1528).

The offer provider 1408 sends a transaction confirmation to the cloud payment server 116 (step 1536), which provides the transaction confirmation to the mobile device 104 (step 1540), thus confirming that the transaction/order has been completed. The offer transaction may then be fulfilled in the manner specified by the comprehensive offer details or pursuant to an arrangement between the user of the mobile device 104 and the individual or entity responsible for the offer.

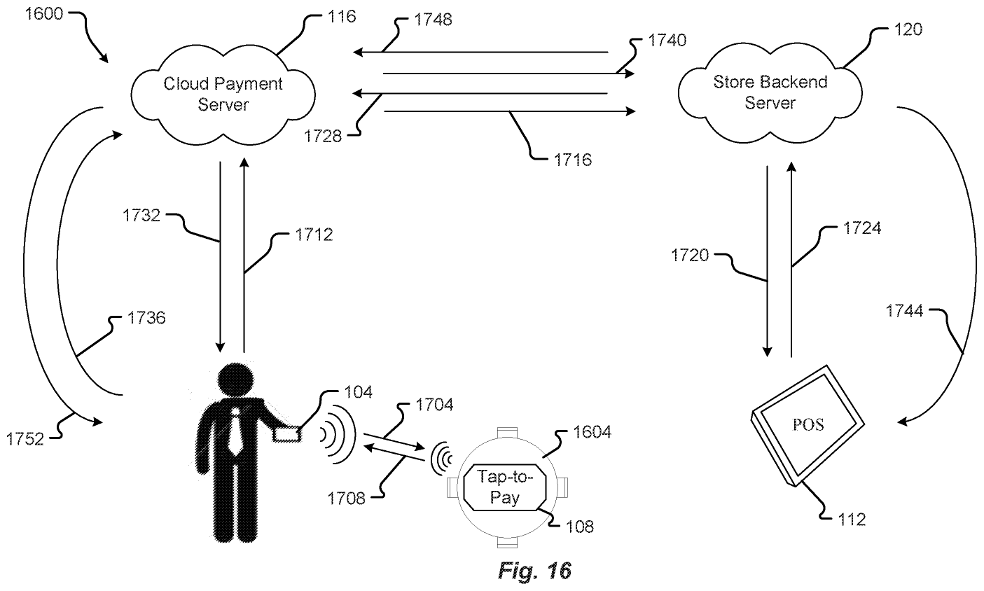

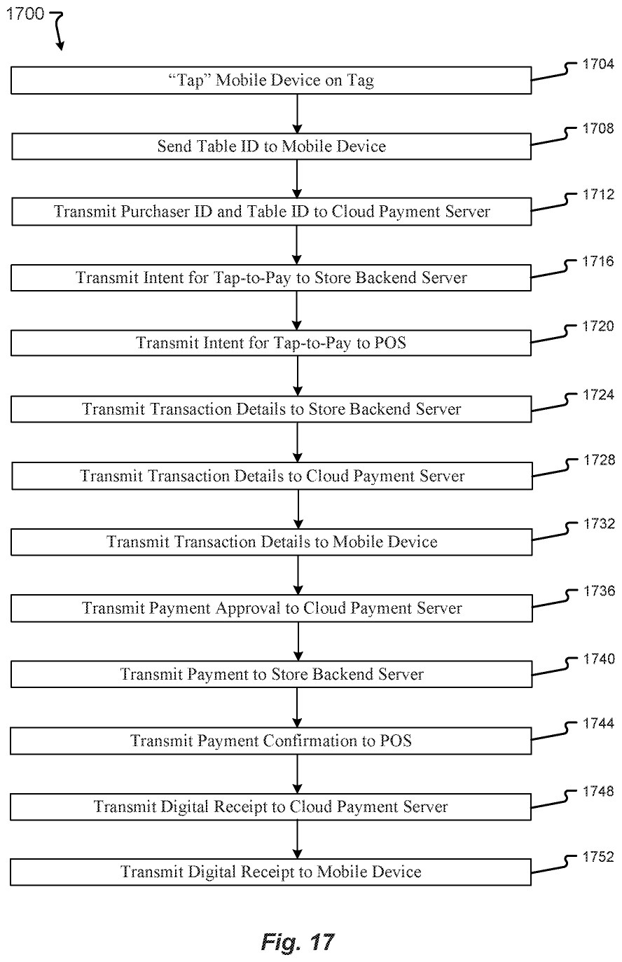

Embodiments of the present disclosure may also be beneficial for use in restaurant scenarios. Referring now to FIG. 16, a system 1600 according to embodiments of the present disclosure comprises a mobile device 104, a tag 108 positioned on or near a restaurant table 1604, a POS terminal 112 to which the restaurant table 1604 has been assigned, a cloud payment server 116, and a store backend server 120. Although FIG. 16 depicts only one table 1604 and one tag 108, the system 1600 may comprise a plurality of tables 1604, each with a tag 108 positioned thereon or nearby. Also, in some embodiments, one or more tags 108 may be associated with other restaurant locations (e.g., bar seats) assigned to the POS terminal 112.

If a user of the mobile device 104 wishes to use the mobile device 104 to pay for the user's restaurant bill, the user taps the mobile device 104 on the tag 108 associated with the user's restaurant table 1604 (step 1704). The user may first need to open a mobile payments application or other application on the mobile device 104. In some embodiments, the mobile payments application may be specifically associated with the entity responsible for the cloud payment server 116. For example, if a bank hosts, controls, or is otherwise responsible for the cloud payment server 116, the same bank may make available to users such as the user of the mobile device 104 a mobile payments application for use in processing transactions through the cloud payment server 116.

The tag 108 returns to the mobile device 104 (and, in some embodiments, to a mobile payments application on the mobile device 104) a table identifier, POS ID, and/or other information stored on the tag 108 (step 1708). The table identifier may be equivalent to the lane number discussed above in connection with FIGS. 5-6. In some embodiments, there may be a many-to-one relationship of customers and tags 108 to POS terminals 112.

The mobile device 104 transmits the table identifier, POS ID, information identifying the user of the mobile device 104, and/or other needed information to the cloud payment server 116 (step 1712), thus indicating the user's intent to use the mobile device 104 (and, in some embodiments, the mobile payments application running on the mobile device 104) to pay for the transaction.

The cloud payment server 116 makes the appropriate data association (e.g., uses information received from mobile device 104 to look up, in a database, the appropriate retail store backend server API to call) and sends appropriate information (e.g., information corresponding to the table identifier, POS ID, and/or user identification) to the store backend server 120 (step 1716).

The store backend server 120 forwards the information to the correct store and further on to the correct POS terminal 112 assigned to the table 1604 at which the user of the mobile device 104 is situated (step 1720), indicating that the user of the mobile device 104 intends to pay for the transaction with the mobile device 104 (and, in some embodiments, with the mobile payments application). This could lead to a notification on the screen of the POS terminal 112 to the clerk that indicates the user's intention to pay for the transaction using the mobile device 104.

The POS terminal 112 provides the latest transaction details to the store backend server 120 (step 1724), and the store backend server 120 transmits the transaction details to the cloud payment server 116 (step 1728). The cloud payment server 116 forwards the transaction details to the mobile device 104 (step 1732).

Whether through a mobile payments application or otherwise, the mobile device 104 displays the provided transaction details for review by the user, and provides the user an option to accept or reject the transaction. The user may also specify any gratuity to be added to the transaction. The user may also specify whether a digital or paper receipt is desired. In some embodiments, the user may approve the transaction by selecting a “Pay” option in a mobile payments application. Regardless of how the transaction is approved or accepted, the mobile device 104 transmits the approval (including, in some embodiments, the final transaction amount and/or a receipt type) to the cloud payment server 116 (step 1736).

The cloud payment server 116 makes the payment to the store backend server 120 for the final transaction amount (step 1740) pursuant to the agreement or arrangement between the owner or host of the cloud payment server 116 and the owner or host of the store backend server 120. The store backend server 120 sends to the POS terminal 112 any receipt type information as well as confirmation that a payment for the final transaction amount (noted as transaction and gratuity) has been received for the table 1604 (step 1744). If a paper receipt was requested, then the POS terminal 112 creates the receipt (e.g. via a receipt printer), which can be provided to the user of the mobile device 104 as confirmation that payment for the transaction at the POS terminal 112 has been made.

If a digital receipt type is specified, then the store backend server 120 provides a digital receipt to the cloud payment server 116 (step 1748), which forward the digital receipt to the mobile device 104 (step 1752). In some embodiments, the store backend server 120 may provide the digital receipt directly to the user of the mobile device 104.

Many of the methods described herein comprise one or more similar steps. Aspects of a step described in connection with one method described herein may be incorporated into a similar or corresponding step from another method disclosed herein. By way of example only, any aspects of any of the steps 204, 404, 604, 904, 1104, 1304, 1504, and 1704 may be incorporated into any other of the steps 204, 404, 604, 904, 1104, 1304, 1504, and 1704. As another example, one or more aspects of any of the steps 208, 408, 608, 908, 1108, 1308, 1508, and 1708 may be incorporated into any other of the steps 208, 408, 608, 908, 1108, 1308, 1508, and 1708. Similarly, any information described as being transmitted between two components of a system described herein, in connection with a step of a first method described herein, may be transmitted between similar or identical components of another system described herein in accordance with a similar or corresponding step of a second method described herein.

In some embodiments, it may also be possible to provide a tag such as the tag 108 that is encoded with table information along with information describing a transaction to complete at the table (e.g., a dinner bill). Thus, the tag may have some data permanently written thereto (e.g., a table identifier) and a waiter may be allowed to rewrite other data on the tag (e.g., meal costs). In other embodiments, a tag without any table identification information written thereon may be placed in a traditional book carried by a waiter or included in a plastic tray that is commonly used by a customer to provide a credit or debit card to the waiter. Alternatively, such a tag could be integrated into the printed paper bill itself. In any event, the tag could be encoded with meal cost information that is sent to a mobile device such as the mobile device 104 in response to the tag being tapped by the mobile device 104 so as to initiate a transaction in which the user pays for the food and service provided during the dining experience. In still other embodiments, a tag could be temporarily encoded with a table identifier corresponding to a table to which the tag will be delivered by a waiter, which table identifier can then be provided to a mobile device such as the mobile device 104 and used to determine the transaction details corresponding to the table in question.

The provisioning/initialization of tags (such as the tags 108) at a merchant's location (e.g., near a POS terminal 112 and/or in association with a mobile merchant's mobile device 304) may be simple enough for the merchant to perform rather than relying upon specialized personnel for provisioning/initialization. The tag(s) may be initialized in a number of ways. For example, in some embodiments, the unique tag serial identifier and/or the unique POS terminal identifier may be programmed at the time of tag production. Also in some embodiments, an application hosted on a mobile device (e.g., a mobile phone, iPad or other tablet, laptop) carried by designated retailer/merchant personnel may be used to write data to the tag. The designated personnel may physically approach the tag, then “tap” the tag with the mobile device, and either manually enter data to be written to the tag (e.g., POS terminal unique identifier data), or tap a POS terminal such as the POS terminal 112 to load the POS terminal identifier into the configuration application, which can then be used to manually write the unique POS terminal identifier to memory of the tag.

In some embodiments, an application, hosted on a mobile device carried by designated retailer/merchant personnel, may be used to send relevant information to a cloud payment server 116 for storage or inclusion in a database stored on or accessible to the cloud payment server 116. Additionally or alternatively, relevant information may be sent to a store backend server 120 for storage or inclusion in a database stored on or accessible to the store backend server 120. The designated personnel may physically approach the tag, then “tap” the tag to obtain the TagID, based upon which information about the tag may be filled in on the configuration application running on the designated personnel's mobile device. The designated personnel may manually enter the unique POS terminal identifier, or may tap the POS terminal to load the POS terminal identifier into the configuration application. This TagID or POS ID data and the unique POS terminal identifier may be sent to a remote database for later use by a cloud payment server 116 or a store backend server 120.

The cloud payment server 116 has been primarily disclosed herein as being separate from the store backend server 120. However, in some embodiments the cloud payment server 116 may communicate directly with a POS terminal 112 for purposes of transaction authorization. Because the order-taking device (e.g., the POS terminal 112) does not necessarily need to handle customer credit card data, the POS terminal 112 or other POS device could be a simple computer device such as a laptop, an iPad or other tablet, or a smartphone. The term “POS” is used for convenience of description and should not be construed as limiting a POS to a particular set of device components. Any device capable of receiving, as an input, a user's purchase request may be used as a POS terminal. A POS terminal such as the POS terminal 112 could be hosted in the cloud and could be physically isolated from the tag without departing from the scope of the present disclosure.

In some embodiments, the store backend server (e.g., the store backend server 120) may be solely responsible for determining a match between the TagID and/or POS ID on the one hand and the transaction (including appropriate transaction details) on the other hand. Alternatively or additionally, the cloud payment server 116 may be solely responsible for determining a match between the TagID and/or POS ID on the one hand and the transaction (including appropriate transaction details) on the other hand. In alternative embodiments, the determination of a match may be performed partially at the store backend server and partially at the cloud payment server. The matching of a TagID and/or POS ID with the transaction may occur at one component or combination of components of a system depicted and described herein.

In some embodiments, a first mobile device 104 is used to tap a tag 108, and a different mobile device (which may be substantially similar if not identical to the mobile device 104) may be asked to approve a payment request or transaction. For example, a parent (having possession of one mobile device) might wish to approve a large purchase made by a minor child (having a different mobile device than the parent). The minor child might tap the tag 108 with the minor child's mobile device, but the payment approval request may be sent to the parent's mobile device. Whether a payment approval request is transmitted to the mobile device that taps the tag or to a different mobile device may be determined by predefined rules, which might be based on, for example, the total cost of a transaction or the cost of individual elements within the transaction.

The systems and methods described herein may comprise additional features. For example, a user may present (tap) a mobile device on a tag at any point during a transaction. This tap may occur before the first item is ordered, or while the user is ordering, or after the user has ordered all desired products.

As another example, the approval screen at the user's mobile device (e.g., the mobile device 104) may be updated dynamically. Thus, as items are added one by one to an order transaction, each newly added item and details associated with that item may be presented to the user at the user's mobile device. In some embodiments, the mobile device display is configured to automatically scroll as each item is added to the order.

As another example, a user may initiate the approval process at any point by swiping (or making another appropriate gesture or input based on the device and application being used to provide the approval) to approve the transaction (thus ending/triggering the completion of the specific transaction). Thus, the order completion is identified by the end user, and not the retailer. The retailer would receive notification of the items approved for purchase.

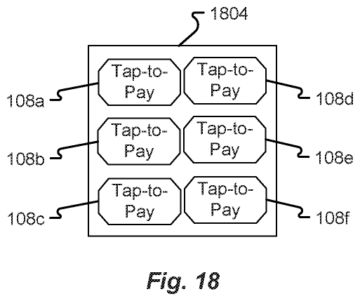

As another example, and with reference now to FIG. 18, a user may be presented with multiple, physically separate tags 108a, 108b, 108c, 108d, 108e, 108f, which may be arranged on a single tag device 1804. Each tag 108a, 108b, 108c, 108d, 108e, 108f may have embedded within it, or associated with it, a description of a payment method to be used for the transaction. Thus, at a retail store such as Target, a user may be presented with a single tag device 1804 comprising one tag 108a that corresponds to the retail store's branded credit card (e.g., the Target credit card), and additional tags 108b, 108c, 108d, 108e, 108f each corresponding to another credit card or payment option (e.g. tag 108b may designated for Visa credit cards; tag 108c may be designated for American Express credit cards; and so forth). By selecting one of those tags to tap, the user is indicating not only the user's intent to make a purchase, but the credit card (from a plurality of cards associated with the user's mobile device) which the user wishes to use for the transaction. Information from these cards needed to process transactions and make payments may be stored either on the mobile device, or in the cloud payment server 116.

It may further be possible to enable a user to select a particular account for use in connection with a transaction. For instance, a user's mobile device may display a plurality of different accounts linked to a mobile payments application on the mobile device. When the user taps a tag with the mobile device, the mobile payments application may present the user with a number of payment options. The user-selected option may then correspond to the specific cloud payment server 116 that will carry out the remainder of the transaction (e.g., by having the POS ID transmitted thereto).

In embodiments of the present disclosure, tags may or may not be physically contained within the same housing as the POS terminal with which they are associated. In some embodiments, the tag may be adjacent but not attached directly to the POS terminal. Also in some embodiments, a tag may be physically attached to the POS terminal (or other transaction processing device) via adhesive or some other mechanism. Such an arrangement may be desirable, for example, in a system 300, where the tag 108 may be physically attached to the mobile device 304 of the mobile merchant. The low cost of the tag 108 is a significant advantage of the present disclosure. Of course, the tag or its equivalent functionality could be embedded within a POS terminal during manufacture of the POS terminal.

Another advantage of the present disclosure is the simplified user experience provided by the systems and methods described herein. The user simply and intuitively taps a mobile device to a physical object (e.g., a tag) to demonstrate the user's intent to complete a transaction. This user experience is far superior to, for example, requiring the user to scan a QR code. Scanning QR codes require the user to 1) physically extract a mobile device from a pocket, purse, or other location, 2) log into the mobile device, 3) bring up the camera application on the mobile device, 4) aim the camera in the direction of the QR code, 5) take the time to focus the camera (perhaps even select a “focus area” on the phone, and 6) click the “take photo button.” This is a cumbersome process that many users would find very unappealing. In contrast, an NFC tag is always “on,” and the user simply needs to tap a mobile device to the NFC tag to initiate the process. The user's authentication request can be sent via current mobile communication technologies that automatically initiate the approval graphical user interface (GUI) on their phone. The authentication of the user's identity on the phone can be frictionless by the use of biometric data such as fingerprint and iris scanning authentication.

Another benefit of the present disclosure is that the user need not release the user's personal data to make a purchase for nominal amounts of money.

Another benefit of the present disclosure is that communications between the user's mobile device and the POS terminal can flow through a cloud payment server and/or store backend server. The mobile device does not have to directly communicate with the POS terminal (although it can), thus protecting the mobile device from viruses on the POS terminal and from leaking Personally Identifiable Information (PII) to the POS terminal.

Another benefit of the present disclosure is that the proposed architecture enables various types of security layers to be established. For instance, separate keys can be shared between unique economic entity relationships. It should be appreciated that private key pairs or public/private key pairs may be used to secure any of these communication channels. These keys can help manage communication between entities involved in the transaction. For example:

The keys used for communication between the POS terminal and store backend server may be controlled and managed entirely by the store backend server.

The keys used for communications from the POS terminal or store backend server to the cloud payment server may be controlled and managed by agreement between the entity controlling or otherwise responsible for the cloud payment system and the entity controlling or otherwise responsible for the store backend server.

The keys used for communications between the user's mobile device and the cloud payment server may be controlled and managed by agreement between the user of the mobile device and the entity controlling or otherwise responsible for the cloud payment server.

The keys used for communications between the tag and the user's mobile device may be managed by agreement between the provider of the mobile application installed on the user's mobile device that is used for communications with the tag, and the tag manufacturer or the entity controlling or otherwise responsible for the store backend server.

In embodiments utilizing a mobile payments application running on the mobile device, the keys used for communication between the mobile payments application as well as the TagID may be controlled and managed by the cloud payment server.

Thus, in order to compromise the security of the system, a hacker would need to: initiate a new, spoofed communication pipe to the target address to indicate that approval is coming from the proper mobile device; and understand the multiple encryption keys being used by the multiple entities. Alternatively, a hacker would need to physically acquire the user's mobile device, spoof the password/biometric security on the mobile device, and physically approach the tag with the mobile device.

In the absence of such knowledge and information, the hacker will be unsuccessful in breaking the system security.

Embodiments of the present disclosure include a method, comprising: presenting a mobile device to a tag; establishing a secure communication channel between the mobile device and the tag; receiving, via the secure communication channel, information encoded on the tag, wherein the information received from the tag includes at least one of a unique identifier assigned to the tag (TagID) and identification information describing a property of a Point Of Service (POS) terminal that is associated with the tag (POS ID); establishing a secure communication channel between the mobile device and a cloud payment server; providing, via the secure communication channel established between the mobile device and the cloud payment server, an identifier associated with the mobile device (mobileID) and one or both of the TagID and POS ID; receiving, at the mobile device and via the secure communication channel established between the mobile device and the cloud payment server, transaction details describing a transaction occurring at the POS terminal concurrent with the mobile device being presented to the tag; rendering, with a user interface of the mobile device, a prompt for a user of the mobile device to accept or deny the transaction occurring at the POS terminal; and based on the user's response to the prompt, providing a message to the cloud payment server that either causes the cloud payment server to complete the transaction occurring at the POS terminal or deny the transaction occurring at the POS terminal.

Aspects of the foregoing method include: wherein the cloud payment server provides a store backend server with a message indicating the user's intent for tap-to-pay that includes one or more of the mobileID, the TagID, and the POS ID; wherein the store backend server provides a message to the POS terminal that indicates the user's intent for tap-to-pay and, in response thereto, provides the store backend server with the transaction details for the transaction occurring at the POS terminal; wherein the transaction details received from the POS terminal are forwarded to the cloud payment server; wherein the user's response to the prompt comprises an acceptance of the transaction and, in response thereto, the cloud payment server provides the store backend server with payment information to satisfy the transaction occurring at the POS terminal; wherein the secure communication channel established between the mobile device and the tag comprises a Near Field Communications (NFC) channel; wherein the secure communication channel established between the mobile device and the tag comprises a Bluetooth channel; providing the store backend server or the POS terminal with coupon information; wherein the coupon information is provided from the mobile device to the cloud payment server and then the coupon information is provided from the cloud payment server to the store backend server for application to the transaction occurring at the POS terminal; wherein the coupon information is provided directly to the POS terminal by the mobile device such that the POS terminal applies the coupon information to the transaction occurring at the POS terminal; wherein the POS terminal comprises a BLE receiver and the coupon information is provided directly to the POS terminal by the mobile device via the BLE receiver; wherein the POS ID comprises a unique identifier assigned to the POS terminal; and wherein the POS ID comprises one or more of a location of the POS terminal, a location of the tag, geolocation information, a retailer identifier, information describing a good or service to be purchased, an offer identifier, an identifier of a mobile merchant's mobile device, a Bluetooth Low Energy (BLE) identifier, a physical position in a queue, a table identifier within a restaurant, and a door identifier.

Embodiments of the present disclosure also include a system comprising: a Point of Service (POS) terminal; a tag positioned within physical proximity of the POS terminal and encoded with information describing the POS terminal (POS ID) as well as a unique identifier assigned to the tag (TagID), wherein the tag is configured to provide one or both of the POS ID and TagID to a mobile device presented thereto via a wireless communication interface; and a store backend server in communication with the POS terminal, wherein the store backend server is configured to receive the POS ID and/or TagID from a cloud payment server and, in response thereto, target a message to the POS terminal based on the POS ID and/or TagID; wherein the POS terminal responds to the message received from the store backend server with one or more transaction details describing a transaction occurring at the POS terminal substantially simultaneously with the mobile device being presented to the tag, such that the one or more transaction details are provided to the mobile device thereby enabling a user of the mobile device to accept or deny the transaction.

Aspects of the foregoing system include: wherein the tag is encoded with a unique identifier assigned to the POS terminal as part of the POS ID; wherein the store backend server is further configured to provide the POS terminal with a confirmation message indicating that payment is received when the user accepts the transaction; and wherein the POS terminal comprises a mobile device carried by a mobile merchant.

Embodiments of the present disclosure further include a system, comprising: a Point of Service (POS) terminal; a tag positioned within physical proximity of the POS terminal and encoded with information describing the POS terminal (POS ID) as well as a unique identifier assigned to the tag (TagID), wherein the tag is configured to provide one or both of the POS ID and TagID via a wireless communication interface to a mobile device presented thereto by a user; and a cloud payment server in communication with the POS terminal; wherein the cloud payment server is configured to receive the POS ID and/or TagID from the tag and, in response thereto, initiate a message that is transmitted to the POS terminal to indicate the user's intent to tap-to-pay for a transaction occurring at the POS terminal substantially simultaneously with the mobile device being presented to the tag; and wherein the cloud payment server is also configured to communicate transaction details from the POS terminal to the user's mobile device such that the transaction can be accepted or denied by the user of the mobile device.

Aspects of the foregoing system include: wherein the message is transmitted to the POS terminal via a store backend server; and wherein upon receiving approval of the transaction details from the mobile device, the cloud payment server transmits payment for the transaction to the store backend server.

A number of variations and modifications of the disclosure can be used. It would be possible to provide for some features of the disclosure without providing others.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

Any of the steps, functions, and operations discussed herein can be performed continuously and automatically.

Examples of processors as described herein may include, but are not limited to, at least one of Qualcomm® Snapdragon® 800, 801 and 845, Qualcomm® Snapdragon® 610 and 615 with 4G LTE Integration and 64-bit computing, Apple® A12, A11, A10X, A10, A9X, A9, ABX, A8, and A7 processors with 64-bit architecture, Apple® M11, M10, M9, M8, and M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™M processors, ARM® Cortex-A and ARN4926EJS™ processors, and other industry-equivalent processors. A processor as disclosed herein may perform computational functions using any known or future-developed standard, instruction set, libraries, and/or architecture.

What is claimed is:

1. A method, comprising:
presenting a mobile device to a tag;
establishing a secure communication channel between the mobile device and the tag;
receiving, via the secure communication channel, information encoded on the tag, wherein the information received from the tag includes at least one of a unique identifier assigned to the tag (TagID) and identification information describing a property of a Point Of Service (POS) terminal that is associated with the tag (POS ID);
establishing a secure communication channel between the mobile device and a cloud payment server;
providing, via the secure communication channel established between the mobile device and the cloud payment server, an identifier associated with the mobile device (mobileID) and one or both of the TagID and POS ID;
receiving, at the mobile device and via the secure communication channel established between the mobile device and the cloud payment server, transaction details describing a transaction occurring at the POS terminal concurrent with the mobile device being presented to the tag;
rendering, with a user interface of the mobile device, a prompt for a user of the mobile device to accept or deny the transaction occurring at the POS terminal; and
based on the user's response to the prompt, providing a message to the cloud payment server that either causes the cloud payment server to complete the transaction occurring at the POS terminal or deny the transaction occurring at the POS terminal.

2. The method of claim 1, wherein the cloud payment server provides a store backend server with a message indicating the user's intent for tap-to-pay that includes one or more of the mobileID, the TagID, and the POS ID.

3. The method of claim 2, wherein the store backend server provides a message to the POS terminal that indicates the user's intent for tap-to-pay and, in response thereto, provides the store backend server with the transaction details for the transaction occurring at the POS terminal.

4. The method of claim 3, wherein the transaction details received from the POS terminal are forwarded to the cloud payment server.

5. The method of claim 2, wherein the user's response to the prompt comprises an acceptance of the transaction and, in response thereto, the cloud payment server provides the store backend server with payment information to satisfy the transaction occurring at the POS terminal.

6. The method of claim 1, wherein the secure communication channel established between the mobile device and the tag comprises a Near Field Communications (NFC) channel.

7. The method of claim 1, wherein the secure communication channel established between the mobile device and the tag comprises a Bluetooth channel.

8. The method of claim 1, further comprising:
providing the store backend server or the POS terminal with coupon information.

9. The method of claim 8, wherein the coupon information is provided from the mobile device to the cloud payment server and then the coupon information is provided from the cloud payment server to the store backend server for application to the transaction occurring at the POS terminal.

10. The method of claim 8, wherein the coupon information is provided directly to the POS terminal by the mobile device such that the POS terminal applies the coupon information to the transaction occurring at the POS terminal.

11. The method of claim 10, wherein the POS terminal comprises a BLE receiver and the coupon information is provided directly to the POS terminal by the mobile device via the BLE receiver.

12. The method of claim 1, wherein the POS ID comprises a unique identifier assigned to the POS terminal.

13. The method of claim 1, wherein the POS ID comprises one or more of the following:
a location of the POS terminal;
a location of the tag;
geolocation information;
a retailer identifier;
information describing a good or service to be purchased;
an offer identifier;
an identifier of a mobile merchant's mobile device;
a Bluetooth Low Energy (BLE) identifier;
a physical position in a queue;
a table identifier within a restaurant; and
a door identifier.

14. A system, comprising:
a Point of Service (POS) terminal;
a tag positioned within physical proximity of the POS terminal and encoded with information describing the POS terminal (POS ID) as well as a unique identifier assigned to the tag (TagID), wherein the tag is configured to provide one or both of the POS ID and TagID to a mobile device presented thereto via a wireless communication interface; and
a store backend server in communication with the POS terminal,
wherein the store backend server is configured to receive the POS ID and/or TagID from a cloud payment server and, in response thereto, target a message to the POS terminal based on the POS ID and/or TagID;
wherein the POS terminal responds to the message received from the store backend server with one or more transaction details describing a transaction occurring at the POS terminal substantially simultaneously with the mobile device being presented to the tag, such that the one or more transaction details are provided to the mobile device thereby enabling a user of the mobile device to accept or deny the transaction.

15. The system of claim 14, wherein the tag is encoded with a unique identifier assigned to the POS terminal as part of the POS ID.

16. The system of claim 14, wherein the store backend server is further configured to provide the POS terminal with a confirmation message indicating that payment is received when the user accepts the transaction.

17. The system of claim 14, wherein the POS terminal comprises a mobile device carried by a mobile merchant.

18. A system, comprising:
a Point of Service (POS) terminal;
a tag positioned within physical proximity of the POS terminal and encoded with information describing the POS terminal (POS ID) as well as a unique identifier assigned to the tag (TagID), wherein the tag is configured to provide one or both of the POS ID and TagID via a wireless communication interface to a mobile device presented thereto by a user; and
a cloud payment server in communication with the POS terminal;
wherein the cloud payment server is configured to receive the POS ID and/or TagID from the tag and, in response thereto, initiate a message that is transmitted to the POS terminal to indicate the user's intent to tap-to-pay for a transaction occurring at the POS terminal substantially simultaneously with the mobile device being presented to the tag; and
wherein the cloud payment server is also configured to communicate transaction details from the POS terminal to the user's mobile device such that the transaction can be accepted or denied by the user of the mobile device.

19. The system of claim 18, wherein the message is transmitted to the POS terminal via a store backend server.

20. The system of claim 19, wherein upon receiving approval of the transaction details from the mobile device, the cloud payment server transmits payment for the transaction to the store backend server.
